(19) United States
(12) Patent Application Publication
(10) Pub. No.: US 2012/0009813 A1
(43) Pub. Date: Jan. 12, 2012

(54) ELECTRICAL CONNECTOR

(76) Inventor: HORNG-YU TSAI, Taoyuan County (TW)

(21) Appl. No.: 13/118,787

(22) Filed: May 31, 2011

(30) Foreign Application Priority Data
Jul. 6, 2010 (TW) 099122249
Oct. 8, 2010 (TW) 099134352

(51) Int. Cl. H01R 4/28

(52) U.S. Cl. 439/347

(57) ABSTRACT

An electrical connector includes a lower base, an upper base, an engaging structure and a driving mechanism. The lower base has at least a terminal slot for accommodating a terminal. The upper base is disposed over said lower base to cover said lower base. The upper base has no integral and downwardly-extended side plate hooking structure to be engaged with the lower base. The engaging structure is used for engaging the upper base with the lower base, so that the upper base is engaged with said lower base and only permitted to be moved forwardly or backwardly relative to the lower base. The driving mechanism is arranged between the upper base and the lower base for driving movement of the upper base and lower base forwardly or backwardly relative to each other.

### RELATED APPLICATIONS

This application claims priority to Taiwan Patent Application Nos. 099122249 filed Jul. 6, 2010; and 099134352 filed Oct. 8, 2010, the entire disclosures of which are hereby incorporated by reference in their entireties.

### FIELD OF THE INVENTION

The present invention relates to an electrical connector, and more particularly to an electrical connector with an upper base and a lower base, which are movable relative to each other.

### BACKGROUND OF THE INVENTION

FIG. 1 and FIG. 2 are respectively schematic side view and perspective view illustrating an electrical connector for a central processing unit (CPU) according to the prior art. The electrical connector 5 comprises a base 90, a covering member 91 and a driving member 92. The covering member 91 comprises a top plate 97 and two side plates 98. The top plate 97 may be disposed over the base 90 to cover the base 90. The two side plates 98 are extended downwardly from left and right edges of the top plate 97, respectively. The side plate 98 has a hook 99 to be engaged with a corresponding engaging surface 901 of the base 90. Consequently, the covering member 91 and the base 90 are restricted to be moved forwardly or backwardly relative to each other in the direction indicated as the arrow B or F. The driving member 92 has a pivotal part 93 and a lever part 94, which are substantially perpendicular to each other. The pivotal part 93 is a shaft body functioning as a cam. Moreover, the pivotal part 93 is pivotally connected between the base 90 and the covering member 91. The lever part 94 may be rotated about a side of the base 90 and the covering member 91. By rotating the lever part 94 in the direction indicated as the arrow R, the covering member 91 is movable forwardly or backwardly relative to the base 90. Moreover, at a location adjacent to the connecting region between the base 90 and the driving member 92, a hook 95 is integrally formed with the base 90. Corresponding to the hook 95, another hook 96 is integrally formed with the covering member 91 to be engaged with the hook 95.

In a case that the driving member 92 is rotated downwardly to have the covering member 91 move forwardly, the hook 96 of the covering member 91 and the hook 95 of the base 90 are securely engaged with each other, so that the covering member 91 and the base 90 are combined together. Due to the engagement between the hooks 95 and 96, even if an upward force is generated during the process of rotating the driving member 92, the possibility of upturning the covering member 91 will be minimized. Consequently, the possibility of damaging the plastic covering member 91 or the base 90 will be reduced.

The conventional electrical connector, however, still has some drawbacks. For example, since the covering member 91 needs to have the downwardly-extended side plates 98, during the covering member 91 is produced by a plastic injection molding process, a stress is generated. Due to the stress, the covering member 91 is readily warped and thus uneven. Under this circumstance, the production yield is reduced. As the size of the covering member 91 is gradually reduced to comply with the miniaturization requirement, the problem of producing the warped and uneven covering member will become more serious.

### SUMMARY OF THE INVENTION

The present invention provides an electrical connector with an upper base and a lower base. The upper base has no integral and downwardly-extended side plate hooking structure to be engaged with the lower base. By using an engaging structure to engage the upper base with the lower base, the upper base is engaged with the lower base and the upper base is restricted to be moved forwardly or backwardly relative to the lower base. In such way, the upper base has enhanced evenness in the fabrication process.

The present also provides an electrical connector with an engaging mechanism. The engaging mechanism is arranged on at least two outer peripheries of the upper base and the lower base to facilitate combining the upper base and the lower base together, thereby improving the engaging efficacy of the hooks of the conventional electrical connector.

The present further provides an electrical connector with an engaging structure to engage the upper base with the lower base. The upper base is made by an insulating flat plate in order to meet the requirements of small size, light weightiness and evenness.

In accordance with an aspect of the present invention, there is provided an electrical connector. The electrical connector includes a lower base, an upper base, an engaging structure and a driving mechanism. The lower base includes a terminal slot for accommodating a terminal. The upper base is disposed over the lower base. An outer periphery of the upper base at least includes an upper-base top surface, an upper-base bottom surface and an upper-base sidewall arranged between the upper-base top surface and the upper-base bottom surface. The upper base is an insulating flat plate. The upper-base top surface and the upper-base bottom surface are flat and have no protruding structure. The engaging structure is used for engaging the upper base with the lower base, so that the upper base is restricted to be moved forwardly or backwardly relative to the lower base. The driving mechanism is arranged between the upper base and the lower base for driving movement of the upper base and lower base forwardly or backwardly relative to each other.

In an embodiment, the engaging mechanism further includes a side plate. The side plate is integrally formed with and protruded from a lower-base top surface of the lower base and extended from an edge of the lower base, wherein the downward engaging surface is protruded from a top edge of the side plate. Alternatively, the engaging mechanism further includes a movable engaging piece. The movable engaging piece is protruded from at least one of left and right edges of the lower-base top surface. An upper segment of the movable engaging piece has a side plate and a downward engaging surface protruded from a top edge of the side plate. A lower segment of the movable engaging piece has a positioning part to be positioned in the lower base. Alternatively, the engaging mechanism further includes a first coupling part, a second coupling part and a position-limiting element. The first coupling part is laterally protruded from the upper-base sidewall at a left side and/or a right side of the upper base, and the upward engaging surface is provided by the first coupling part. Corresponding to the first coupling part, the second coupling part is laterally protruded from a lower-base sidewall at a left side and/or a right side of the lower base to provide the downward engaging surface. The movable position-limiting element has at least one fastening slot. The first coupling part and the second coupling part are allowed to be penetrated through the fastening slot and engaged with the fastening slot.

In an embodiment, the upward engaging surface is provided by the upper-base top surface to be engaged with the downward engaging surface. Alternatively, the upward engaging surface is provided by a plurality of bulges, which are discretely arranged on the upper-base sidewall at a left or right side of the upper base to be engaged with the downward engaging surface. Alternatively, the upward engaging surface is provided by a contiguous bulge, which is arranged on and longitudinally extended from the upper-base sidewall at a left or right side of the upper base, so that the contiguous bulge and a portion of the upper-base top surface at the same side of the contiguous bulge are collectively engaged with the downward engaging surface. Alternatively, the upward engaging surface is provided by the upper-base top surface to be engaged with the downward engaging surface which is provided by the movable engaging piece. A first perforation is formed at a left edge and/or a right edge of the upper base. A second perforation and a fastening slot corresponding to the first perforation are formed in a left edge and/or a right edge of the lower base. The movable engaging piece is penetrated through the first perforation and the second perforation, and the positioning part is positioned in the fastening slot. Alternatively, a first perforation is formed in a left edge and/or a right edge of the upper-base top surface corresponding to the downward engaging surface of the movable engaging piece. The upward engaging surface is arranged in the first perforation and exposed to the upper-base top surface. A second perforation and a fastening slot corresponding to the first perforation are formed in the left edge and/or the right edge of the lower base. The movable engaging piece is penetrated through the first perforation and the second perforation to be engaged with the upward engaging surface. Alternatively, a notch is formed in a left edge and/or a right edge of the upper-base top surface corresponding to the downward engaging surface of the movable engaging piece. The upward engaging surface is arranged in the notch and exposed to the upper-base top surface. A perforation and a fastening slot corresponding to the first perforation are formed in the left edge and/or the right edge of the lower base. The movable engaging piece is penetrated through the perforation and the notch to be engaged with the upward engaging surface. Alternatively, the upward engaging surface is provided by the upper-base top surface to be engaged with the downward engaging surface, and a notch is formed in a left edge and/or a right side of the upper base. After the upper base is placed on the lower base from top to bottom, the downward engaging surface provided by the movable engaging piece is received by the notch. Alternatively, the positioning part of the movable engaging piece has an elastic inverted hook for facilitating fixing the movable engaging piece in the lower base. Alternatively, the fastening slot of the movable position-limiting element includes a wide hole and a narrow hole, which are in communication with each other. The first coupling part and the second coupling part are penetrated through the wide hole. The narrow hole is engaged with the first coupling part and the second coupling part. Alternatively, the movable position-limiting element includes a plurality of separate movable position-limiting portions, and the fastening slot of each movable position-limiting element comprises a wide hole and a narrow hole, which are in communication with each other. The first coupling part and the second coupling part are penetrated through the wide hole. The narrow hole is engaged with the first coupling part and the second coupling part. Alternatively, the fastening slot of the movable position-limiting element includes an open hole and a narrow hole, wherein the first coupling part and the second coupling part are penetrated through the open hole, and the narrow hole is engaged with the first coupling part and the second coupling part.

In an embodiment, the upper base is an insulating flat plate. The driving mechanism includes a handle with a lever part and a pivotal part. A shaft is disposed at both ends of the pivotal part. A cam is disposed at a middle of the pivotal part. The shaft is coupled with the lower base. Upon rotation of the cam, the upper base is driven to be moved relative to the lower base. Alternatively, the driving mechanism includes a moving element and a pushing element. The upper base has an opening, the moving element has a through-hole and is coupled to and fixed on the base. The pushing element has a slot in a top surface thereof and an eccentric cam corresponding to a center of the slot. The eccentric cam is received within the through-hole. The slot is exposed to the opening of the upper base. Upon rotation of the pushing element, the moving element is pushed by the eccentric cam, so that the upper base is driven to be moved relative to the lower base.

In an embodiment, the upper base is an insulating flat plate, and the upper-base top surface and the upper-base bottom surface are flat and have no protruding structure. Moreover, the side plate of the lower base is a contiguous plate, and the downward engaging surface is divided into multiple segments of separate surfaces. Alternatively, the downward engaging surface is divided into multiple segments of separate first surfaces, and the side plate is divided into multiple segments of separate second surfaces and engaged with the downward engaging surface. Alternatively, corresponding to the movable engaging piece, at least one fastening slot is formed in a left edge and/or a right edge of the low-base top surface of the lower base.

In an embodiment, the electrical connector further includes a conduction mechanism and a chip package. The conduction mechanism is installed on at least one of the upper base and the lower base for transferring a physical signal. The chip package is supported on the upper base, and includes a top surface, a bottom surface, a sidewall connected with the top surface and the bottom surface and a plurality of metal pins protruded outside the chip package. The metal pins are penetrated through a plurality of insertion holes to be electrically connected with respective terminals.

In an embodiment, the conduction mechanism includes a thermal conduction mechanism or an electrical conduction mechanism. The thermal conduction mechanism is disposed on the upper-base top surface, the upper-base bottom surface, a lower-base top surface of the lower base, a lower-base bottom surface of the lower base, within at least one of the insertion holes, within at least one of the terminal slots and/or on at least one of the metal pins. The electrical conduction mechanism includes a laminate with at least one electrically-conductive layer. The laminate is disposed on a part of the upper base or the lower base.

In an embodiment, the conduction mechanism includes a thermal conduction mechanism or an electrical conduction mechanism. Moreover, the thermal conduction mechanism includes a first thermal conduction mechanism, which is in contact with the bottom surface or the sidewall of the chip package or in contact with at least one signal pin, one ground pin or one power pin of the metal pins of the chip package, wherein the first thermal conduction mechanism is a metal plate, an electrically-conductive pad, a fastener, a wire or a solder ball. Alternatively, at least one part of the engaging structure and the driving mechanism is made of a metallic material, and at least one thermal conduction path is established between the part and the first thermal conduction mechanism. Alternatively, the thermal conduction mechanism includes a first thermal conduction mechanism and a second thermal conduction mechanism, wherein the first thermal conduction mechanism is in contact with the bottom surface or the sidewall of the chip package or in contact with at least one signal pin, one ground pin or one power pin of the metal pins of the chip package, the second thermal conduction mechanism is not in contact with the bottom surface or the sidewall of the chip package or not in contact with each of the metal pins, and at least one thermal conduction path is established between the second thermal conduction mechanism and the first thermal conduction mechanism. Alternatively, the electrical conduction mechanism includes a laminate with at least one electrically-conductive layer, and the laminate is disposed on a part of the upper base or the lower base. Alternatively, the electrical conduction mechanism at least includes a first electrical conduction mechanism and a second electrical conduction mechanism, wherein the first electrical conduction mechanism is in contact with the bottom surface of the chip package or the metal pins of the chip package, the second electrical conduction mechanism is disposed on a location of the electrical connector which is not in contact with the chip package, and an electrical conduction path is established between the second electrical conduction mechanism and the first electrical conduction mechanism.

In an embodiment, the electrically-conductive layer at least includes a ground layer or a power layer. Alternatively, at least one metal substrate, one metal wire, one thermally-conductive pad, one thermally-conductive terminal, one thermally-conductive hole, one metallic fastener or one solder ball is disposed on the laminate to be electrically with at least one signal pin, one ground pin or one power pin of the metal pins. Alternatively, the second thermal conduction mechanism includes a thermally-conductive ring or a solder ball or other heat-dissipating or cooling mechanism. Alternatively, an electronic component is further in communication with the electrical conduction mechanism, wherein the electronic component includes a capacitor, a capacitive structure, an inductor, an inductive structure, an active/passive electronic component, an active/passive electronic structure, an electromagnetic interference (EMI) protection element or an electrostatic discharge (ESD) protection element.

In an embodiment, each of the upper base and the lower base further includes a thermal conduction mechanism or an electrical conduction mechanism, at least one part of the engaging structure and the driving mechanism is made of a metallic material, and at least one thermal conduction path is established between the part and the first thermal conduction mechanism.

In an embodiment, the electrical conduction mechanism includes a laminate with at least one electrically-conductive layer, and the laminate is disposed on a part of the upper base or the lower base.

In an embodiment, the engaging structure includes a movable engaging piece, which is protruded from at least one of left and right edges of a lower-base top surface of the lower base. An upper segment of the movable engaging piece has a side plate and a downward engaging surface protruded from a top edge of the side plate. A lower segment of the movable engaging piece has a positioning part to be positioned in the lower base. The thermal conduction path is established between the part and the thermal conduction mechanism through the movable engaging piece.

In accordance with another aspect of the present invention, there is provided an electrical connector. The electrical connector includes a lower base, an upper base, an engaging mechanism and a driving mechanism. The engaging structure at least includes a movable upward engaging surface and a downward engaging surface installed on the lower base. After the movable upward engaging surface is engaged with the downward engaging surface, the upper base is engaged with the lower base and the upper base is movable forwardly or backwardly relative to the lower base. In addition, the movable upward engaging surface is located at a level not higher than the downward engaging surface.

In an embodiment, each of the upper base and the lower base further includes a thermal conduction mechanism or an electrical conduction mechanism, at least one part of the engaging structure and the driving mechanism is made of a metallic material, and at least one thermal conduction path is established between the part and the first thermal conduction mechanism.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating an electrical connector for a central processing unit according to the prior art;

FIG. 2 is a schematic perspective view illustrating an electrical connector for a central processing unit according to the prior art;

FIG. 3 is a schematic exploded view illustrating an electrical connector according to a first embodiment of the present invention;

FIG. 4 is a schematic perspective assembled view illustrating the electrical connector according to the first embodiment of the present invention;

FIG. 5 is a schematic bottom view illustrating a pushing element of the electrical connector according to the first embodiment of the present invention;

FIG. 6 is a schematic perspective view illustrating an assembling structure of the clamping element and the driving mechanism according to the first embodiment of the present invention;

FIG. 7 is a schematic exploded view illustrating an electrical connector according to a second embodiment of the present invention;

FIG. 8 is a schematic perspective view illustrating the electrical connector according to the second embodiment of the present invention;

FIG. 9 is a schematic perspective view illustrating an assembling structure of the clamping element and the driving mechanism according to the second embodiment of the present invention;

FIG. 10 is a schematic exploded view illustrating an electrical connector according to a third embodiment of the present invention;

FIG. 11 is a schematic exploded view illustrating an electrical connector according to a fourth embodiment of the present invention;

FIG. 12 is a schematic perspective and top view illustrating the electrical connector according to the fourth embodiment of the present invention;

FIG. 13 is a schematic perspective and bottom view illustrating the electrical connector according to the fourth embodiment of the present invention;

FIG. 14 is a schematic exploded view illustrating an electrical connector according to a fifth embodiment of the present invention;

FIG. 15 is a schematic perspective and top view illustrating the electrical connector according to the fifth embodiment of the present invention;

FIG. 16 is a schematic exploded view illustrating a driving mechanism of the electrical connector according to the fifth embodiment of the present invention;

FIG. 17 is a schematic exploded view illustrating an electrical connector according to a sixth embodiment of the present invention;

FIG. 18 is a schematic perspective view illustrating the electrical connector according to the sixth embodiment of the present invention;

FIG. 19 is a schematic exploded view illustrating an electrical connector according to an eighth embodiment of the present invention;

FIG. 20 is a schematic perspective view illustrating the electrical connector according to the eighth embodiment of the present invention;

FIG. 21 is a schematic exploded view illustrating the moving element and the upper base of an electrical connector according to a ninth embodiment of the present invention;

FIG. 22 is a schematic assembled view illustrating the moving element and the upper base of the electrical connector according to the ninth embodiment of the present invention;

FIG. 23 is a schematic exploded view illustrating the moving element and the upper base of an electrical connector according to a tenth embodiment of the present invention;

FIG. 24 is a schematic assembled view illustrating the moving element and the upper base of the electrical connector according to the tenth embodiment of the present invention;

FIG. 25 is a schematic exploded view illustrating the moving element and the upper base of an electrical connector according to an eleventh embodiment of the present invention;

FIG. 26 is a schematic assembled view illustrating the moving element and the upper base of the electrical connector according to the eleventh embodiment of the present invention;

FIG. 27 is a schematic partial exploded view illustrating an electrical connector according to a twelfth embodiment of the present invention;

FIG. 28 is a schematic partial perspective view illustrating a process of assembled the electrical connector according to the twelfth embodiment of the present invention;

FIG. 29 is a schematic partial assembled view illustrating the electrical connector according to the twelfth embodiment of the present invention;

FIG. 30 is a schematic partial exploded view illustrating an electrical connector according to a thirteenth embodiment of the present invention;

FIG. 31 is a schematic partial assembled view illustrating the electrical connector according to the thirteenth embodiment of the present invention;

FIG. 32 is a schematic partial exploded view illustrating an electrical connector according to a fourteenth embodiment of the present invention;

FIG. 33 is a schematic side view illustrating a position-limiting element of an electrical connector according to a fifteenth embodiment of the present invention;

FIG. 34 is a schematic partial exploded view illustrating an electrical connector according to a sixteenth embodiment of the present invention;

FIG. 35 is a schematic side view illustrating a position-limiting element of an electrical connector according to a seventeenth embodiment of the present invention;

FIG. 36 is a schematic partial assembled view illustrating the electrical connector according to an eighteenth embodiment of the present invention;

FIG. 37 is a schematic partial exploded view illustrating an electrical connector according to a nineteenth embodiment of the present invention;

FIG. 38 is a schematic partial assembled view illustrating the electrical connector according to the nineteenth embodiment of the present invention;

FIG. 39 is a schematic cross-sectional view illustrating a combination of an electrical connector and a chip package according to a twentieth embodiment of the present invention;

FIG. 40 is a schematic cross-sectional view illustrating a combination of an electrical connector, a chip package and a system board according to a twenty-first embodiment of the present invention;

FIG. 41 is a schematic partial assembled view illustrating an electrical connector of the present invention; and

FIG. 42 is a schematic partial cross-sectional view illustrating an electrical connector of the present invention.

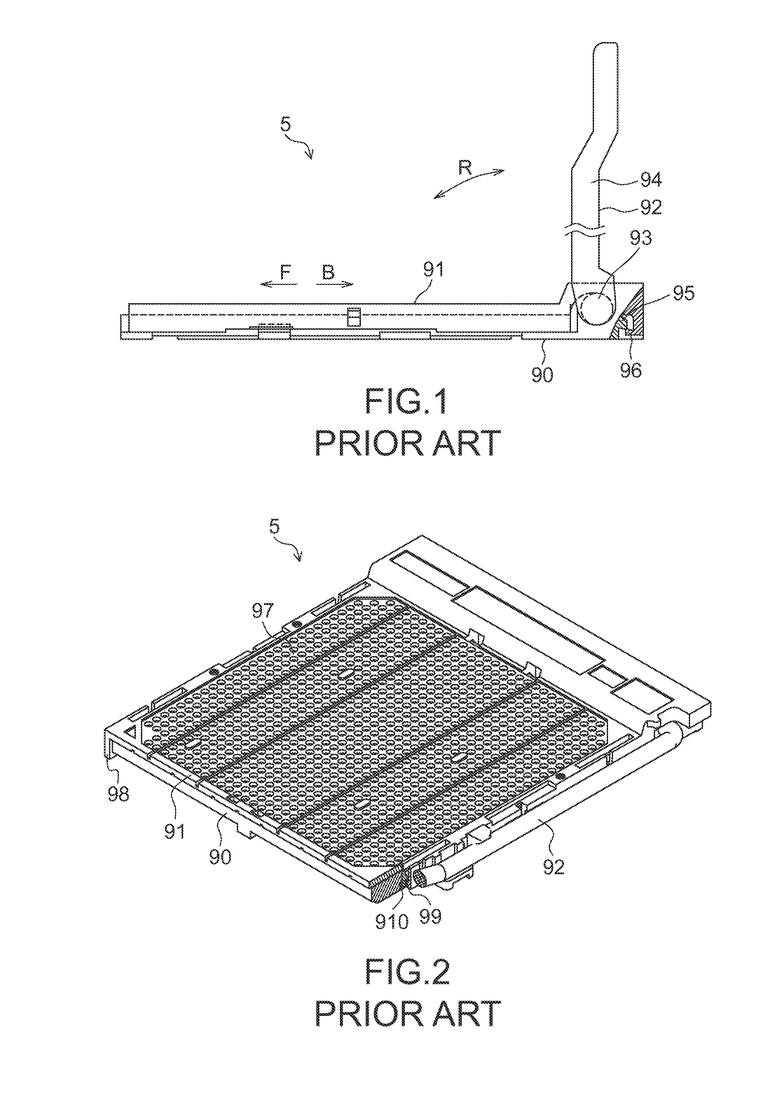

### DETAILED DESCRIPTION OF THE PREFERRED EMBODIMENT

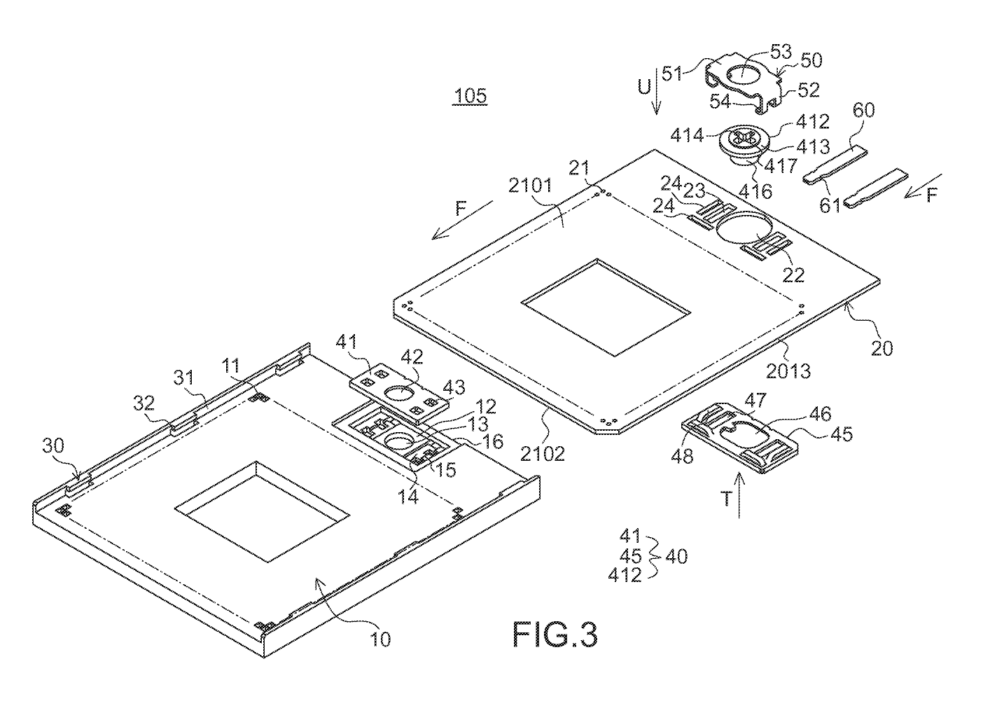

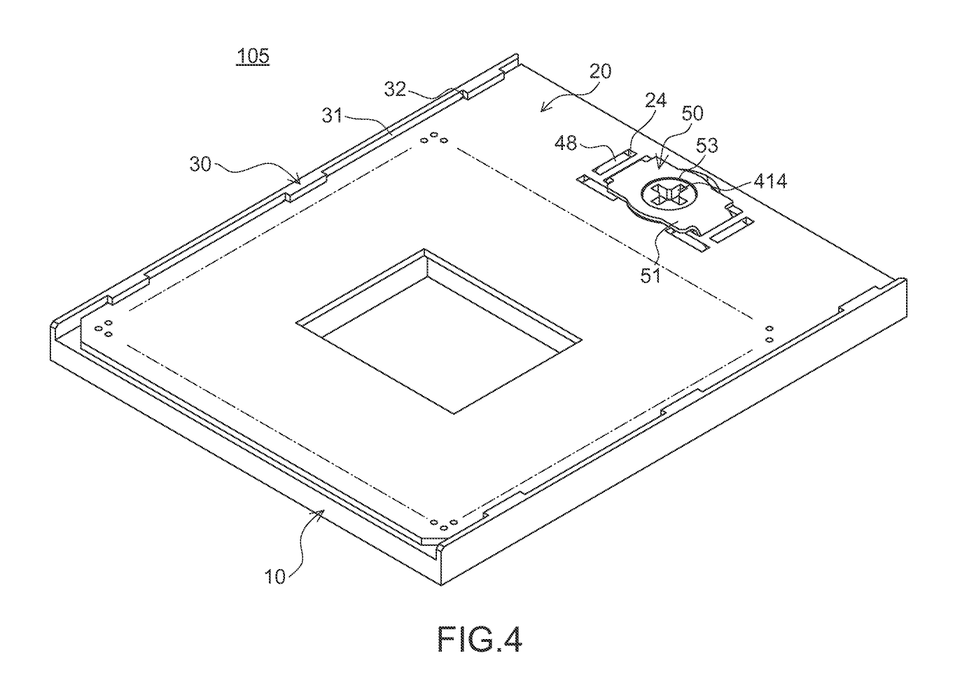

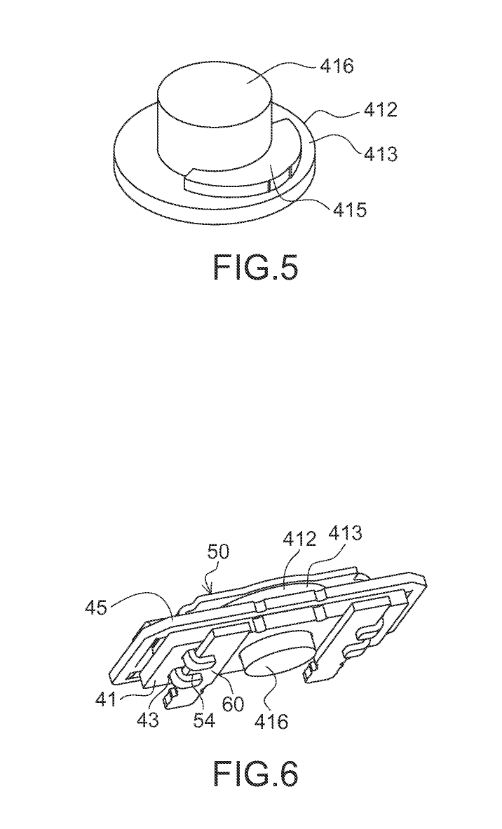

FIG. 3 is a schematic exploded view illustrating an electrical connector according to a first embodiment of the present invention. FIG. 4 is a schematic perspective assembled view illustrating the electrical connector according to the first embodiment of the present invention. FIG. 5 is a schematic bottom view illustrating a pushing element of the electrical connector according to the first embodiment of the present invention. FIG. 6 is a schematic perspective view illustrating an assembling structure of the clamping element and the driving mechanism according to the first embodiment of the present invention. In the first embodiment, the electrical connector 105 comprises a lower base 10, an upper base 20, a driving mechanism 40 and an engaging mechanism. The electrical connector 105 is configured to support a central processing unit (CPU) of a chip package (not shown). Through the electrical connector 105, the central processing unit can be attached to an external medium (e.g. a motherboard). Moreover, through a plurality of terminals of the electrical connector 105, the central processing unit can be electrically connected with the external medium.

The lower base 10 comprises multiple rows of terminal slots 11, which are arranged in an array. For clarification and brevity, only the terminal slots 11 disposed at the corners of the lower base 10 are shown. The terminal slots 11 are used for accommodating respective terminals (not shown). In addition, a recess 12 is formed at a side of the lower base 10 for accommodating the driving mechanism 40. A circular hole 13 is formed in the middle of the recess 12. Two longitudinal fastening slots 14 are respectively disposed at opposite sides of the circular hole 13. Each of the fastening slots 14 has an upright opening 15. In addition, an entrance 16 is disposed at a rear end of the fastening slot 14.

The outer periphery of the upper base 20 at least comprises an upper-base top surface 2101, an upper-base bottom surface 2102 and an upper-base sidewall 2103. The upper-base sidewall 2103 is arranged between the upper-base top surface 2101 and the upper-base bottom surface 2102. The upper base 20 comprises multiple rows of insertion holes 21, which are arranged in an array. For clarification and brevity, only the insertion holes 21 disposed at the corners of the upper base 20 are shown. These insertion holes 21 correspond to the terminal slots 11 of the lower base 10. In addition, corresponding to the circular hole 13 of the lower base 10, a circular opening 22 is formed at a side of the upper base 20. One longitudinal perforation 23 and two fastening holes 24 are arranged at each of opposite sides of the circular opening 22. The two fastening holes 24 are perpendicular to each other. The upper base 20 may be placed on the lower base 10 to cover the lower base 10 and movable relative to the lower base 10. In the first embodiment, the whole upper base 20 is a flat plate made of insulating material. That is, the upper-base top surface 2101 and the upper-base bottom surface 2102 are flat and have no protruding structure. Therefore, any side plates extended downwardly from bilateral sides of the covering member of the conventional electrical connector are not included in the upper base 20.

The engaging mechanism comprises a downward engaging surface and an upward engaging surface. When the downward engaging surface and the upward engaging surface are engaged with each other, the upper base 20 is engaged with the lower base 10, and the upper base 20 is movable relative to the lower base 10. Moreover, the upward engaging surface is located at a level not lower than the downward engaging surface.

In the first embodiment, the engaging mechanism comprises an engaging structure 30, which is integrally formed with the lower base 10. The engaging structure 30 is protruded from a side plate 31 of the lower base 10, wherein the side plate 31 is formed on at least one of the left and right edges of the top surface of the lower base 10. The engaging structure 30 is protruded from a top edge of the side plate 31 to define the downward engaging surface 32 of the engaging mechanism. On the other hand, the upward engaging surface of the engaging mechanism is provided by the upper-base top surface 2101 of the upper base 20. The upper-base top surface 2101 is located at a level not lower than the upper-base bottom surface 2102. Moreover, the upper-base top surface 2101 can be engaged with the downward engaging surface 32. It is noted that, in the first embodiment, a plurality of engaging structures 30 are integrally formed with the lower base 10 by a plastic injection molding process. These engaging structures 30 are discretely arranged on the sidewalls 31. Moreover, numerous modifications and alterations may be made while retaining the teachings of the invention. For example, a contiguous engaging structure 30 is connected with the side plate 31. Moreover, the side plates 31 in the first embodiment may be modified. For example, a plurality of separate side plates 31 may be discretely protruded from an edge of the top surface of the lower base 10.

The driving mechanism 40 (e.g. a screw driving assembly) comprises a fixing slice 41, a moving element 45 and a pushing element 412. The fixing slice 41 is positioned in a recess 12 of the lower base 10. The fixing slice 41 has a pivotal aperture 42 corresponding to the circular hole 13 of the lower base 10. Two perforations 43 are arranged at each of opposite sides of the pivotal aperture 42. A through-hole 46 is arranged at the middle of the moving element 45. A longitudinal perforation 47 and two protruding parts 48 are arranged at each of opposite sides of the through-hole 46. The two protruding parts 48 are perpendicular to each other. After the protruding parts 48 are penetrated through corresponding fastening holes 24 of the upper base 20 from bottom to top, the moving element 45 is combined with the upper base 20.

Please refer to FIGS. 3 and 5. The pushing element 412 comprises a screw head 413. A smaller raised surface 417 is formed on the middle of the screw head 413. A cross-form slot 414 is formed in the raised surface 417. An eccentric cam 415 and a shaft 416 are disposed under the screw head 413. In addition, the shaft 416 is disposed just under the cross-form slot 414.

During the assembling process, the pushing element 412 is firstly inserted into the circular opening 22 of the upper base 20. Consequently, the screw head 413 is sustained against the moving element 45, the eccentric cam 415 is received within the through-hole 46, and the cross-form slot 414 is exposed to the circular opening 22 of the upper base 20. Then, the shaft 416 of the pushing element 412 is coupled with the pivotal aperture 42 of the fixing slice 41, which is positioned on the lower base 10. Upon rotation of the pushing element 412, the moving element 45 is pushed by the eccentric cam 415, and thus the upper base 20 is driven to be moved relative to the lower base 10.

Moreover, the electrical connector 105 further comprises a clamping element 50, which is substantially inversed U-shaped. The clamping element 50 comprises a pressing surface 51 and two hooking parts 52. The pressing surface 51 has an opening 53. The opening 53 is smaller than the circular opening 22 of the upper base 20. Moreover, the opening 53 may be sheathed around the raised surface 417 of the pushing element 412. The two hooking parts 52 are respectively connected to bilateral sides of the pressing surface 51. Moreover, each of the hooking parts 52 is extended downwardly and then bent to have a horizontal engaging surface 54. The longitudinal perforation 23 of the upper base 20 and the longitudinal perforation 47 of the moving element 45 are both longer than the hooking part 52. Please refer to FIGS. 4 and 6. The clamping element 50 is moved from top to bottom to be attached on the upper base 20, thereby clamping the driving mechanism 40. The pressing surface 51 is pressed on the upper base 20 and disposed over the driving mechanism 40. After the two hooking parts 52 are penetrated through the longitudinal perforation 23 of the upper base 20, the longitudinal perforation 47 of the moving element 45 and the perforations 43 of the fixing slice 41, the two hooking parts 52 are inserted into the fastening slots 14 through the openings 15. Then, two insertion pins 60 are respectively inserted into the fastening slots 14 through the entrance 16 and engaged with the engaging surfaces 54 of the hooking parts 52 of the clamping element 50. Moreover, an inverted thorn 61 is formed at an end of the pin 60 for facilitating engagement between the pin 60 and the lower base 10.

A process of assembling the electrical connector 105 will be illustrated as follows. The assembled process is presented for purpose of illustration and description only. The assembled process comprises the following steps. Firstly, in the step (a), the fixing slice 41 is accommodated within the recess 12, and the moving element 45 is fixed onto the bottom surface of the upper base 20 from bottom to top (in the direction indicated as the arrow T). Then, in the step (b), the upper base 20 is placed on the lower base 10 from back to front (in the direction indicated as the arrow F), wherein the bilateral sides and the top side of the upper base 20 is confined by the engaging structure 30 and the downward engaging surface 32 is engaged with the upper-base top surface 2101. Then, in the step (c), the clamping element 50 is moved from top to bottom (in the direction indicated as the arrow U) to clamp the upper base 20 and the driving mechanism 40. That is, after the two hooking parts 52 are penetrated through the longitudinal perforation 23 of the upper base 20, the longitudinal perforation 47 of the moving element 45 (in the direction indicated as the arrow T) and the perforations 43 of the fixing slice 41, the two hooking parts 52 are inserted into the fastening slots 14. Afterwards, in the step (d), the insertion pins 60 are inserted into the fastening slots 14 through the entrance 16 from back to front (in the direction indicated as the arrow F) and engaged with the engaging surfaces 54 of the hooking parts 52 of the clamping element 50. In such way, the upper base 20, the driving mechanism 40 and the lower base 10 are securely combined together.

Moreover, by using a suitable tool (e.g. a screwdriver) to drive the cross-form slot 414, the pushing element 412 may be rotated. Since the clamping element 50 is attached on the lower base 10, upon rotation of the pushing element 412, the moving element 45 is pushed by the eccentric cam 415 of the pushing element 412. In such way, the upper base 20 is movable forwardly and backwardly relative to the clamping element 50 and the lower base 10.

From the above discussions, after the two hooking parts 52 of the clamping element 50 are penetrated through the upper base 20, the moving element 45 and the fixing slice 41, the clamping element 50 is attached on the lower base 10. In other words, the upper base 20, the lower base 10 and the driving mechanism 40 are all clamped by the clamping element 50. The pushing element 412 can be securely positioned on the lower base 10 without the help of any riveting means. Therefore, the assembling convenience is enhanced, and the driving mechanism 40 is securely clamped.

A process of producing the upper base 20 of the electrical connector 105 will be illustrated as follows. Firstly, an insulating flat plate is provided. Then, the insulating flat plate is punched and cut into an upper base. Consequently, the upper base 20 comprises a plurality of insertion holes 21, which are arranged in an array. The insulating flat plate is a plastic flat plate or a glass fiber flat plate. In addition, the upper base 20 is configured to support at least one central processing unit (CPU).

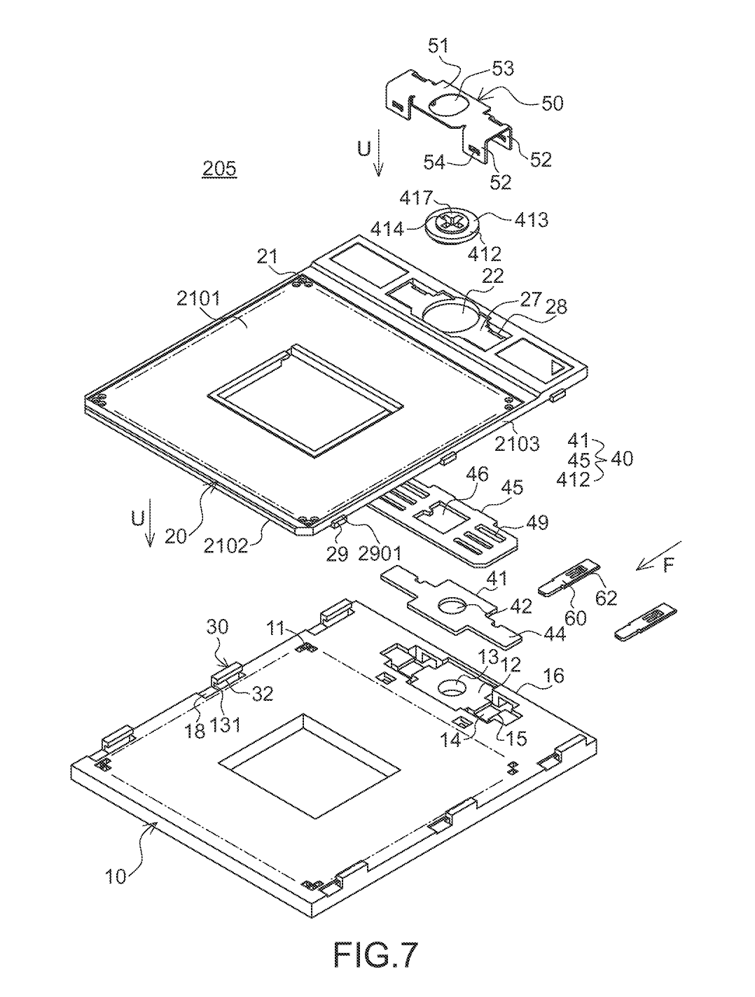

Hereinafter, an electrical connector according to a second embodiment of the present invention will be illustrated with reference to FIGS. 7, 8 and 9. In this embodiment, the electrical connector 205 comprises a lower base 10, an upper base 20, a driving mechanism 40 and an engaging mechanism.

In comparison with the first embodiment, the circular opening 22 of the upper base 20 of the electrical connector 205 is formed in a concave surface 27 of the upper base 20. Corresponding to the circular hole 13 of the lower base 10, two transverse perforations 28 are respectively arranged at opposite sides of the circular opening 22. Moreover, a plurality of bulges 29 are discretely arranged on the upper-base sidewall 2103 of the upper base 20. The top surface 2901 of the bulge 29 is arranged between the upper-base top surface 2101 and the upper-base bottom surface 2102. Alternatively, the bulge 29 is a contiguous bulge with a contiguous top surface 2901. It is noted that numerous modifications and alterations may be made while retaining the teachings of the invention.

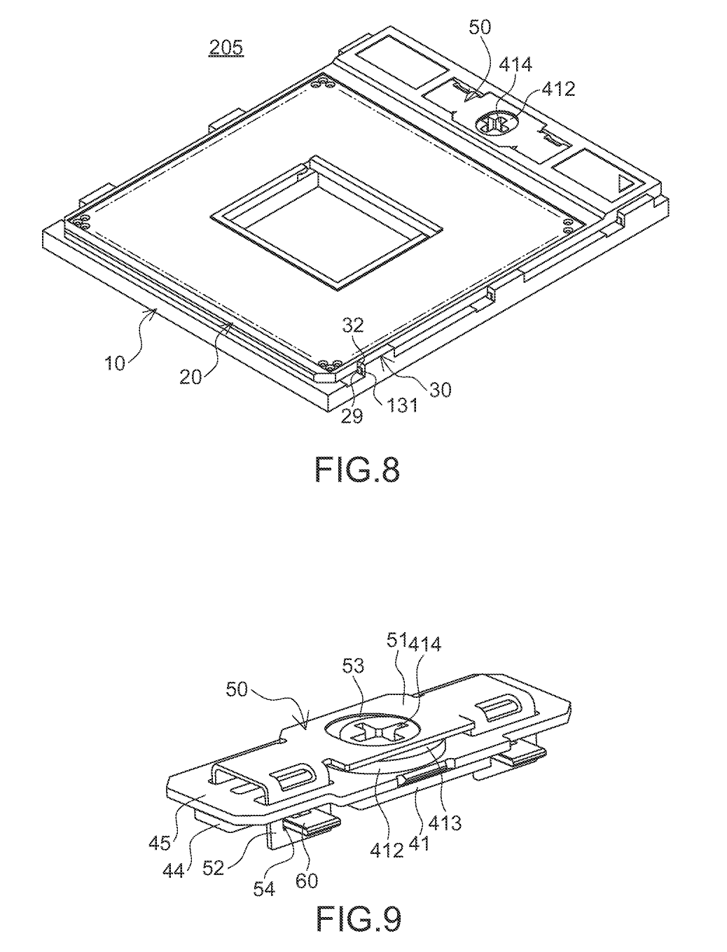

In comparison with the first embodiment, the engaging mechanism of the electrical connector 205 comprises an engaging structure 30, which is integrally formed with the lower base 10. The engaging structure 30 is protruded from a side plate 131 of the lower base 10, wherein the side plate 131 is formed on at least one of the left and right edges of the top surface of the lower base 10. In this embodiment, a plurality of engaging structures 30 are discretely arranged on a plurality of side plates 131 of the lower base 10. On contrast, the side plate 31 of the first embodiment is a contiguous side plate. Moreover, each of the side plates 131 has a notch mating with a corresponding bulge 29 of the upper base 20. That is, in the second embodiment, the engaging structure 30 provides a downward engaging surface of the engaging mechanism, and the top surface 2901 of the bulge 29 provides an upward engaging surface of the engaging mechanism. As shown in FIG. 8, the engaging structure 30 and the top surface 2901 of the bulge 29 can be engaged with each other.

In comparison with the first embodiment, the fixing slice 41 has a pivotal aperture 42 corresponding to the circular hole 13 of the lower base 10. Two narrow lateral parts 44 are respectively arranged at bilateral sides of the fixing slice 41. A through-hole 46 is arranged at the middle of the moving element 45. Three transverse perforations 49 are arranged at each of opposite sides of the through-hole 46. The constituents and the assembling relation of the pushing element 412 are similar to those of the first embodiment, and are not redundantly described herein.

In comparison with the first embodiment, the clamping element 50 comprises a pressing surface 51 and four hooking parts 52. The pressing surface 51 has an opening 53. The opening 53 is smaller than the circular opening 22 of the upper base 20. These four hooking parts 52 are respectively connected to the front and rear ends of the left and right sides of the pressing surface 51 and extended downwardly. Consequently, the left and right sides of the clamping element 50 are substantially inverted U-shaped. The hooking part 52 has a fastening hole. A lower edge of the fastening hole has a horizontal engaging surface 54.

Please refer to FIG. 9 again. The clamping element 50 is moved from top to bottom to be attached on the upper base 20, thereby clamping the driving mechanism 40. The pressing surface 51 is pressed on the upper base 20, and the clamping element 50 is disposed over the driving mechanism 40. After the four hooking parts 52 are penetrated through the transverse perforations 28 of the upper base 20 and the transverse perforations 49 of the moving element 45 to stride over the two lateral parts 44 of the fixing slice 41, the four hooking parts 52 are inserted into the fastening slots 14 through the openings 15. Upon rotation of the pushing element 412, the clamping element 50 and the upper base 20 are moved relative to the lower base 10. Since the width of the opening 15 is greater than the width of the inverted U-shaped hooking parts 52 at the left or right side of the clamping element 50, the opening 15 provides a space of moving the clamping element 50. Then, two insertion pins 60 are respectively inserted into the fastening slots 14 through the entrance 16, and clasped at the position over the engaging surfaces 54 of the hooking parts 52 of the clamping element 50 and under the two lateral parts 44 of the fixing slice 41. Moreover, the pin 60 has an elastic inverted buckle 62 (see FIG. 7). By pressing the elastic inverted buckle 62, the pin 60 may be disengaged and detached.

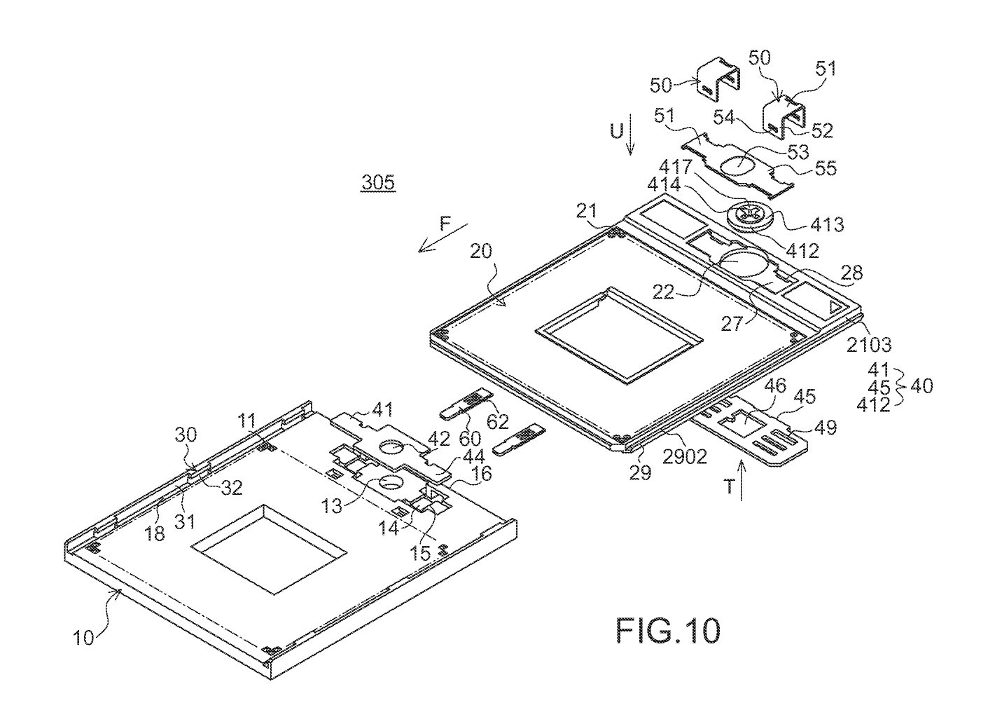

Hereinafter, an electrical connector according to a third embodiment of the present invention will be illustrated with reference to FIG. 10. As for the engaging mechanism of the electrical connector 305 of this embodiment, the side plate 31 of the first embodiment and the concave surface of the second embodiment are employed and the downward engaging surface 32 is provided by the separate engaging structures. Moreover, in comparison with the second embodiment, the bulge 29 of the electrical connector 305 is a contiguous bulge arranged on the upper-base sidewall 2103. The contiguous top surface 2902 of the bulge 29 provides an upward engaging surface of the engaging mechanism.

Moreover, the electrical connector 305 comprises two smaller separate clamping elements 50 and a pressing plate 55. These two clamping elements 50 are sheathed around bilateral sides of the pressing plate 55. The cooperation of the two clamping elements 50 and the pressing plate 55 can achieve the similar efficacy of the clamping elements 50 of the second embodiment.

In the above embodiments, the upper base and the lower base of the electrical connector are combined together by the engaging mechanism. Since the two downwardly-extended side plates of the covering member of the conventional electrical connector are not included in the upper base, the upper base is more even and not warped during the upper base is produced by a plastic injection molding process. As the trend of designing the electrical connector is toward small size and light weightiness, the upper base of the present invention becomes more important and valuable. It is noted that the upward engaging surface and the downward engaging surface of the engaging mechanism are not restricted to those described in the above embodiments. That is, numerous modifications and alterations of the engaging mechanism may be made while retaining the teachings of the invention.

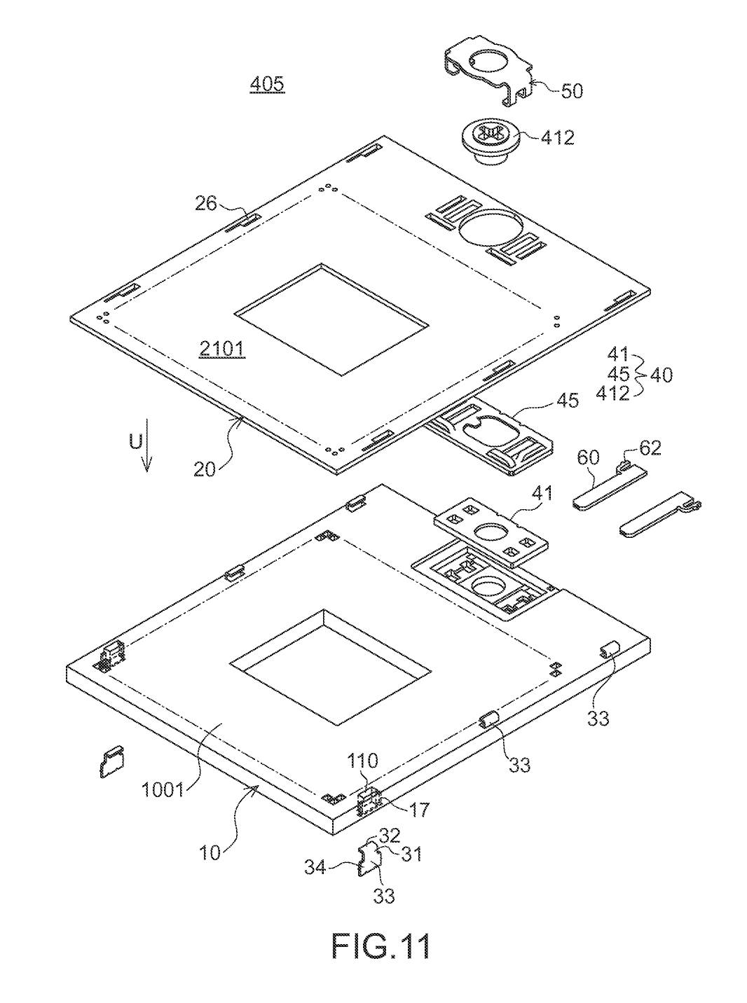

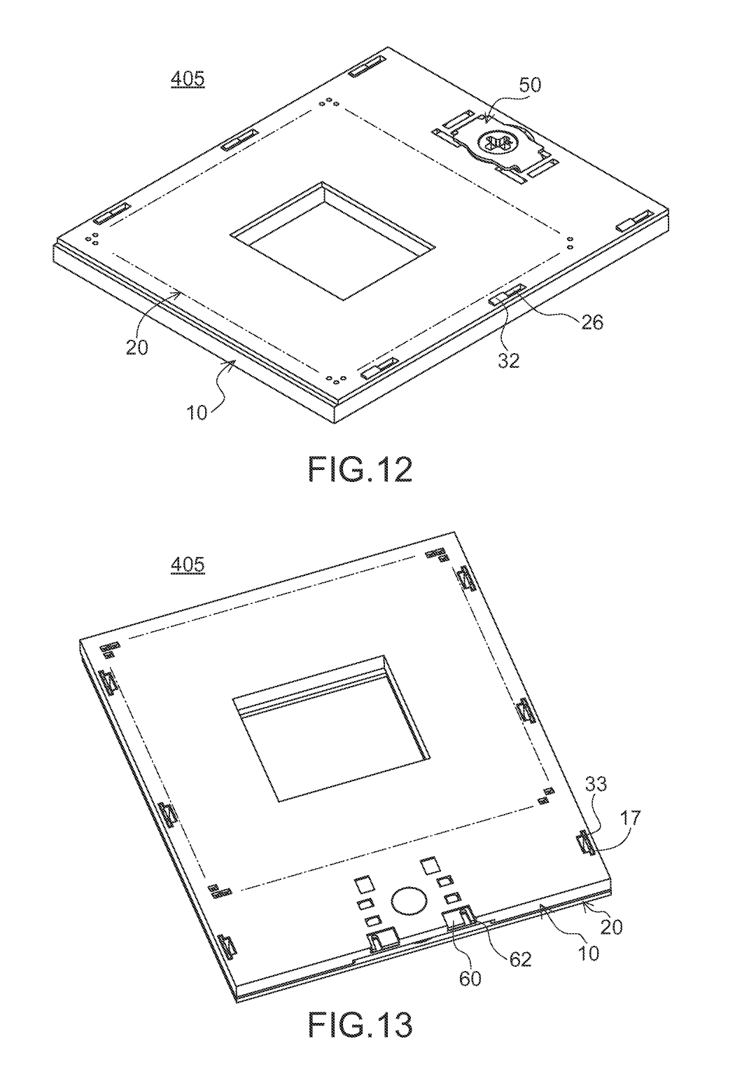

Hereinafter, an electrical connector according to a fourth embodiment of the present invention will be illustrated with reference to FIGS. 11, 12 and 13. The engaging mechanism of the electrical connector 405 comprises a plurality of movable engaging pieces 33. The movable engaging pieces 33 are detachable from the lower base 10. Each of the movable engaging pieces 33 is made by bending a metal sheet. The upper segment of the movable engaging piece 33 has a longitudinally-extended side plate 31. In addition, a downward engaging surface 32 is protruded from a top edge of the side plate 31. The lower segment of the movable engaging piece 33 has a positioning part 34. Via the positioning part 34, the movable engaging piece 33 can be positioned in the lower base 10.

Moreover, corresponding to these movable engaging pieces 33, a plurality of fastening slots 17 and a plurality of perforations 110 are formed at the edges of a lower-base top surface 1001 of the lower base 10 of the electrical connector 405.

Moreover, corresponding to the fastening slots 17 and the perforations 110, a plurality of perforations 26 are formed in the upper-base top surface 2101 of the electrical connector 405. The geometric shape of each perforation 26 is not limited to these examples. In this embodiment, the perforation 26 includes a front-segment wide part and a rear-segment narrow part, wherein the front-segment wide part and the rear-segment narrow part are in communication with each other.

In the fourth embodiment, the downward engaging surfaces 32 of the engaging mechanism are provided by these movable engaging pieces 33, and the upward engaging surface of the engaging mechanism is provided by the upper-base top surface 2101. For assembling the upper base 20 and the lower base 10, the wide part of the perforation 26 of the upper base 20 is firstly aligned with the movable engaging piece 33, and then the movable engaging piece 33 is moved from top to bottom to be inserted into a corresponding fastening slot 17 and a corresponding perforation 110 of the lower base 10. Then, the upper base 20 is moved forwardly or backwardly until the movable engaging piece 33 is engaged with the upper-base top surface 2101.

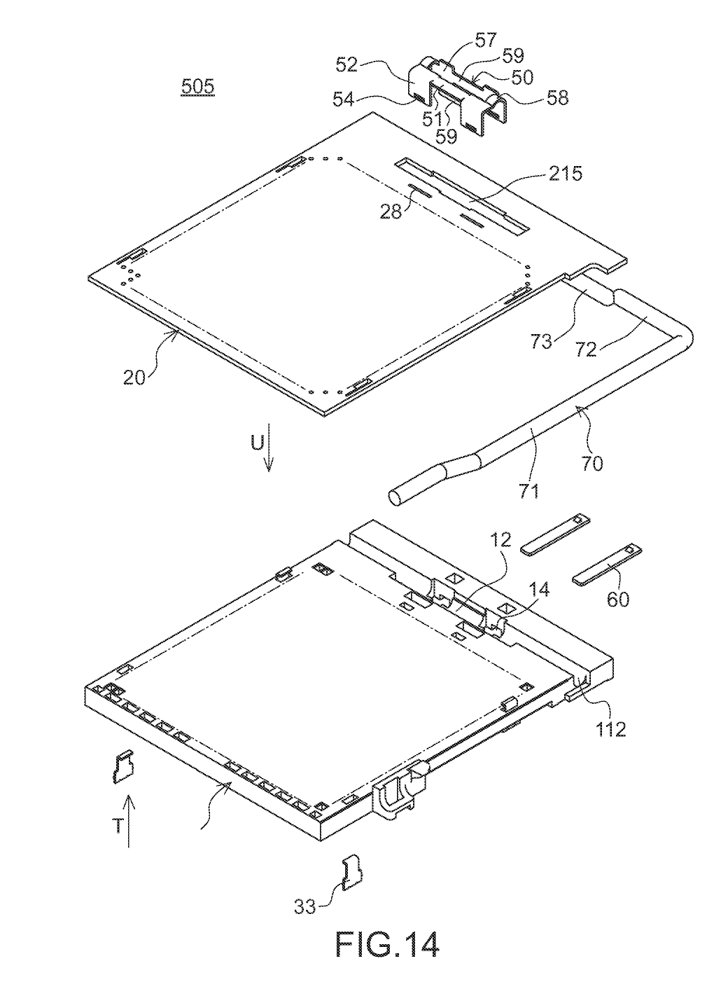

Hereinafter, an electrical connector according to a fifth embodiment of the present invention will be illustrated with reference to FIGS. 14, 15 and 16. In comparison with the fourth embodiment, the driving mechanism of the electrical connector 505 comprises a handle 70. The handle 70 comprises a cam 73, a shaft 72 and lever part 71, which are connected with each other. The shaft 72 is substantially perpendicular to the lever part 71. The upper base 20 is an insulating flat plate. A plurality of transverse perforations 28 and an elongated transverse opening 215 are arranged at a side of the upper base 20. Corresponding to the perforations 28 and the opening 215, a recess 12 and a plurality of fastening slots 14 are arranged at a side of the lower base 10. Moreover, the clamping element 50 comprises a pressing surface 51, a fastening part 57 and a plurality of hooking parts 52. The fastening part 57 is arranged at the backside of the pressing surface 51. The fastening part 57 comprises two opposite clamping surfaces 59 and two arc-shaped top surfaces 58. These hooking parts 52 are transversely arranged and downwardly extended, and symmetrically connected with the bilateral sides of the pressing surface 51 and the fastening part 57.

During the assembling process, the clamping element 50 is moved from top to bottom to clamp the upper base 20 and the handle 70, and the pressing surface 51 is pressed on the upper base 20. The fastening part 57 is penetrated through the elongated transverse opening 215 and coupled with the cam 73 of the handle 70. The hooking parts 52 are penetrated through the transverse perforations 28 and the elongated transverse opening 215 of the upper base 20 and the recess 12 of the lower base 10. Then, two insertion pins 60 are respectively inserted into the fastening slots 14 and clasped at the position over the engaging surfaces 54 of the hooking parts 52 of the clamping element 50 and under the cam 73 of the handle 70. By the clamping element 50, the upper base 20, the handle 70 and the lower base 10 can be securely combined together. Moreover, during the handle is rotated, the cam 73 is allowed to be protruded outside the elongated transverse opening 215 of the upper base 20.

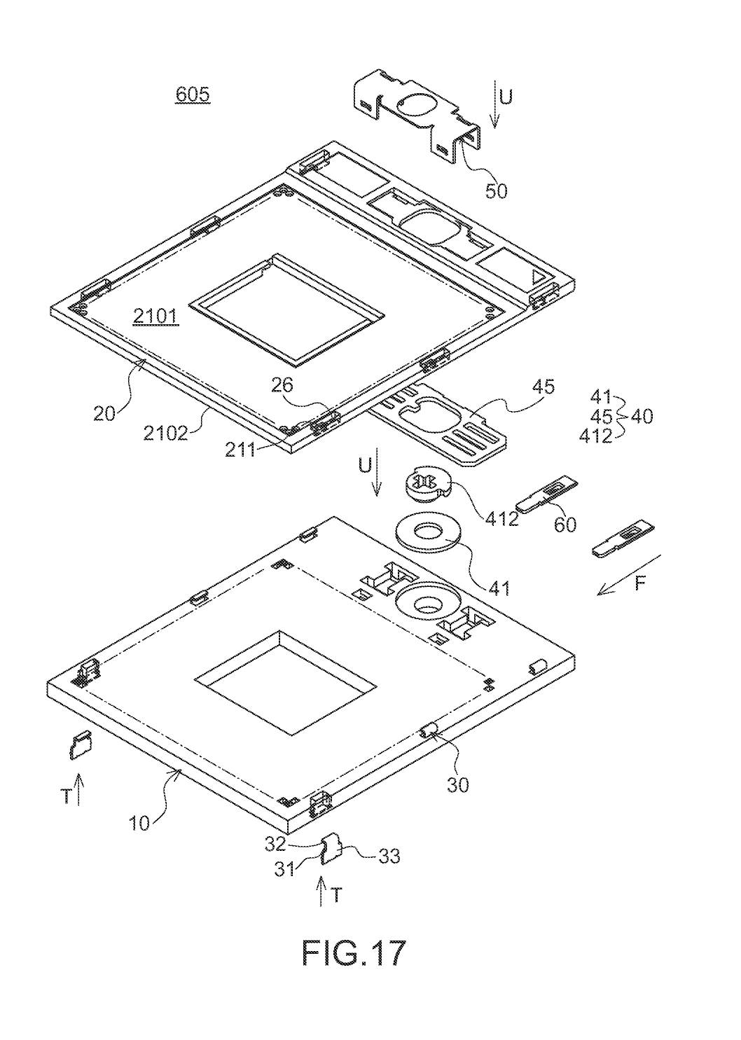

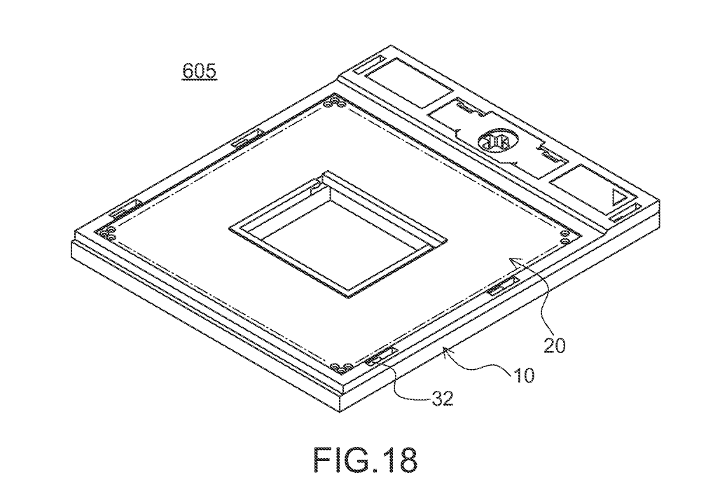

Hereinafter, an electrical connector according to a sixth embodiment of the present invention will be illustrated with reference to FIGS. 17 and 18. In comparison with the fourth embodiment, the upper-base top surface 2101 of the electrical connector 605 comprises a plurality of perforations 26. The perforations 26 are formed in the edge of the upper-base top surface 2101. An upward engaging surface 211 is arranged at an end of a corresponding perforation 26 and exposed to the perforation 26 and the upper-base top surface 2101. The upward engaging surface 211 is also arranged between the upper-base top surface 2101 and the upper-base bottom surface 2102. After the movable engaging pieces 33 are fixed in the bilateral sides of the lower base 10, the movable engaging pieces 33 may be penetrated through the perforations 26 to be engaged with the upward engaging surfaces 211.

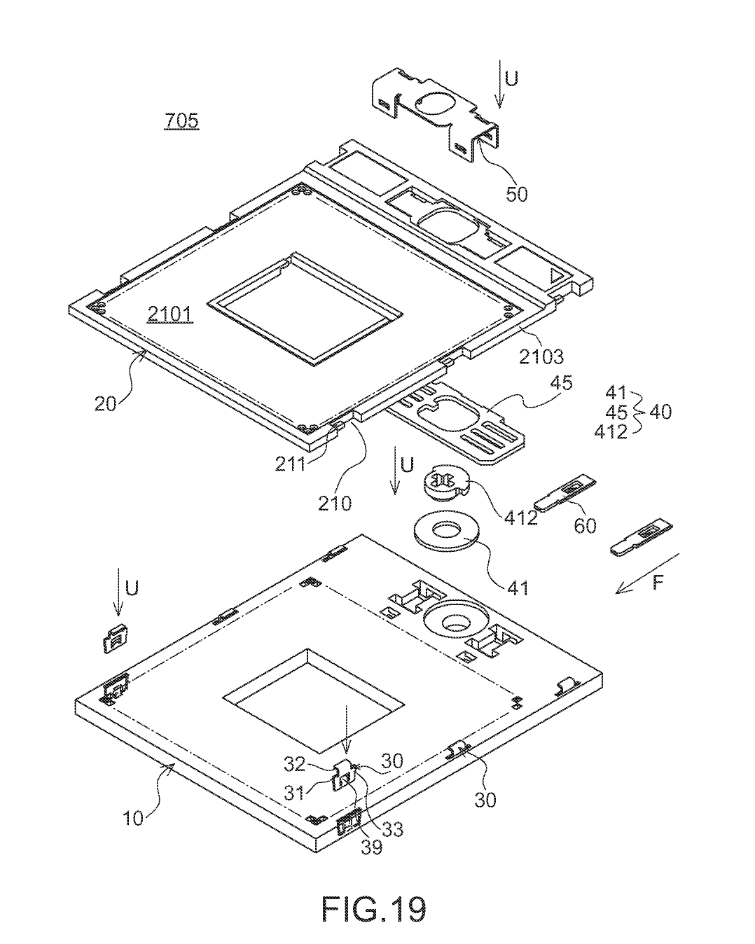

Hereinafter, an electrical connector according to a seventh embodiment of the present invention will be illustrated with reference to FIG. 19. In the electrical connector 705 of this embodiment, a plurality of notches 210 are formed in the upper-base sidewall 2103 to replace the perforations 26 of the electrical connector 605 of the sixth embodiment. In other words, an upward engaging surface 211 is arranged at an end of a corresponding notch 210 and exposed to the notch 210 and the upper-base top surface 2101. After the movable engaging pieces 33 are fixed in the bilateral sides of the lower base 10, the downward engaging surfaces 32 of the movable engaging pieces 33 may be received in the notches 210 to be engaged with the upward engaging surfaces 211. Moreover, in this embodiment, the positioning part of the movable engaging piece 33 has an elastic inverted hook 39 for facilitating fixing the movable engaging piece 33 in the lower base 10.

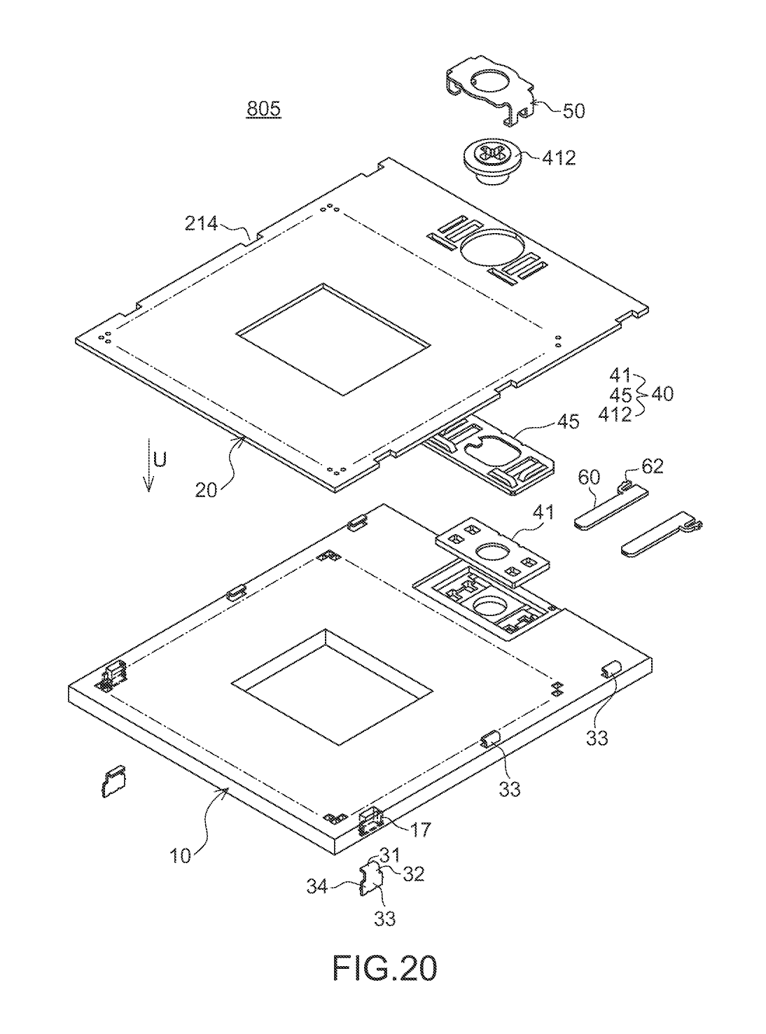

Hereinafter, an electrical connector according to an eighth embodiment of the present invention will be illustrated with reference to FIG. 20. In comparison with the seventh embodiment, the upward engaging surface of the engaging mechanism of the electrical connector 805 is also provided by the upper-base top surface 2101.

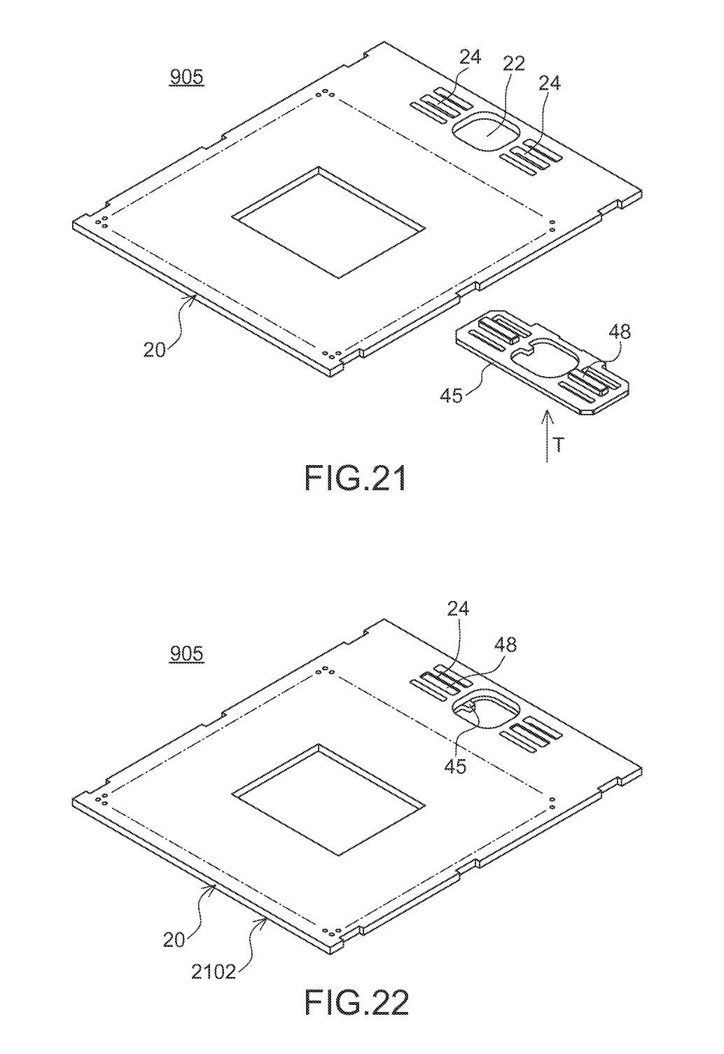

FIGS. 21 and 22 are respectively schematic exploded and assembled view illustrating the moving element and the upper base of an electrical connector according to a ninth embodiment of the present invention. In comparison with the seventh embodiment of FIG. 19, a transverse fastening hole 24 is arranged at the middle region of each of the opposite sides of the opening 22 of the upper base 20 of the electrical connector 905. A transverse protruding part 48 is arranged at the middle region of each of the bilateral side of the moving element 45. The moving element 45 is positioned in the upper-base bottom surface 2102, wherein the two protruding parts 48 of the moving element 45 are engaged with the fastening holes 24 at the middle regions of the opposite sides of the upper base 20.

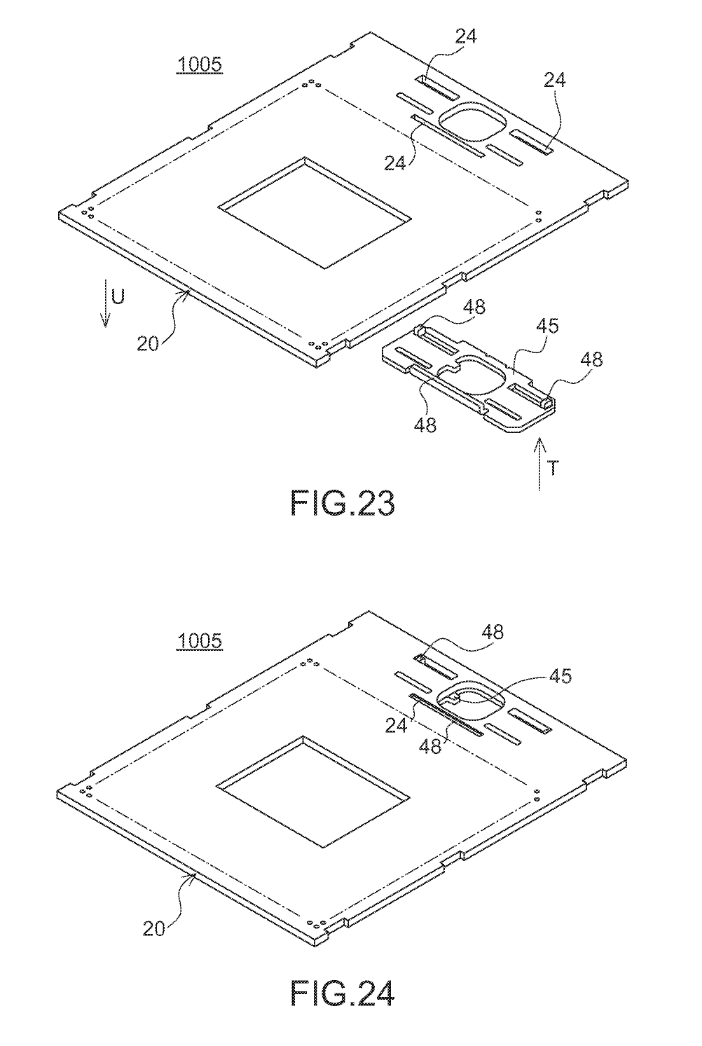

FIGS. 23 and 24 are respectively schematic exploded and assembled view illustrating the moving element and the upper base of an electrical connector according to a tenth embodiment of the present invention. In comparison with the eighth embodiment of FIG. 20, the locations of the fastening holes 24 and the protruding parts 48 of the electrical connector 1005 are distinguished. The other components are similar to those of the eighth embodiment, and are not redundantly described herein.

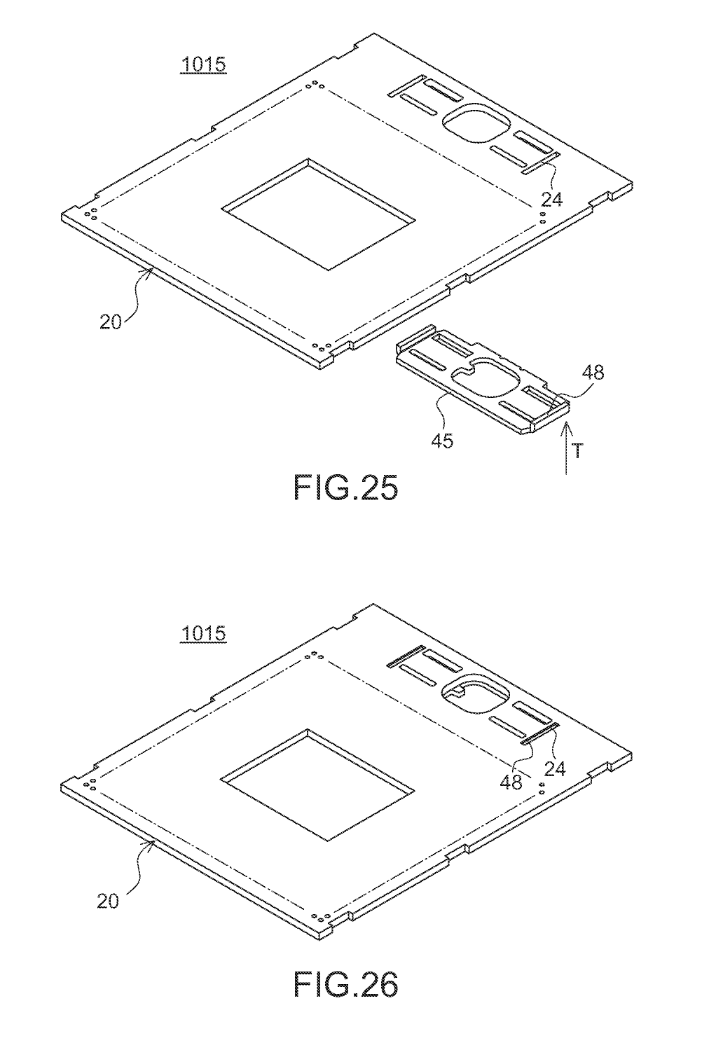

FIGS. 25 and 26 are respectively schematic exploded and assembled view illustrating the moving element and the upper base of an electrical connector according to an eleventh embodiment of the present invention. In the eleventh embodiment, the locations of the fastening holes 24 and the protruding parts 48 of the electrical connector 1015 are varied. The other components are similar to those of the eighth embodiment, and are not redundantly described herein.

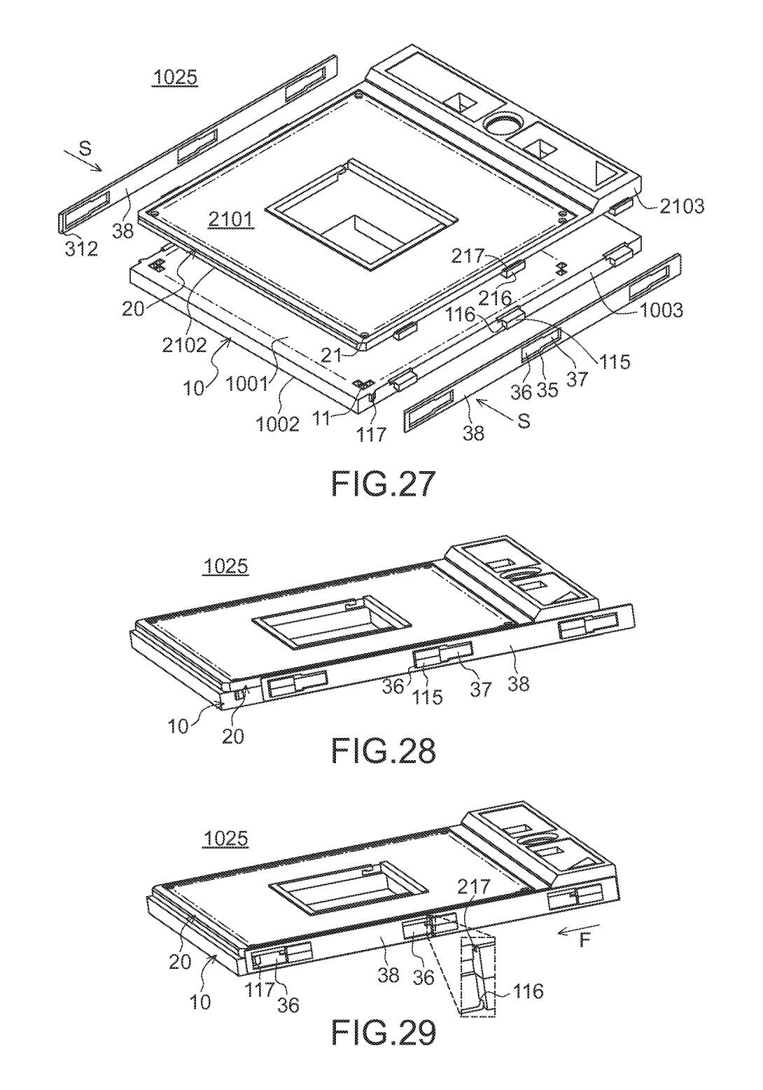

FIG. 27 is a schematic partial exploded view illustrating an electrical connector according to a twelfth embodiment of the present invention. FIG. 28 is a schematic partial perspective view illustrating a process of assembled the electrical connector according to the twelfth embodiment of the present invention. FIG. 29 is a schematic partial assembled view illustrating the electrical connector according to the twelfth embodiment of the present invention. The engaging mechanism of the electrical connector 1025 comprises a plurality of first coupling parts, a plurality of second coupling parts and a plurality of movable position-limiting elements. The other components or structures of the electrical connector 1025 are combinations of identical or different components of the above embodiments, and are not redundantly described herein.

The first coupling parts 216 are discretely arranged on and protruded from the upper-base sidewall 2103. Each of the first coupling parts 216 is an upwardly-stepped block with a recessed upward engaging surface 217. The upward engaging surface 217 is arranged between the upper-base top surface 2101 and the upper-base bottom surface 2102. In other words, the first coupling part 216 provides engaging mechanism of the electrical connector 1025 with the upward engaging surface 217.

The second coupling parts 115 are discretely arranged on and protruded from a lower-base sidewall 1003 of the lower base 10. The locations of the second coupling parts 115 correspond to the locations of respective first coupling parts 216. Each of the second coupling parts 115 is a downwardly-stepped block with a recessed downward engaging surface 116. The downward engaging surface 116 is arranged between the lower-base top surface 1001 and a lower-base bottom surface 1002.

The engaging mechanism further comprises a plurality of longitudinal elongated sheet-like movable position-limiting elements 38. Each of the movable position-limiting elements 38 comprises a plurality of separate fastening parts 35. Each of the fastening parts 35 is a fastening slot composed of a wide hole 36 and a narrow hole 37, wherein the wide hole 36 and the narrow hole 37 are in communication with each other.

During the assembling process, the first coupling part 216 of the upper base 20 is aligned with the second coupling part 115 of the lower base 10, then the movable position-limiting element 38 is moved toward the electrical connector 115 in the direction indicated as the arrow S, and then the first coupling part 216 and the second coupling part 115 are simultaneously accommodated within the wide hole 36 of the movable position-limiting element 38. Then, by moving the movable position-limiting element 38 in the direction indicated as the arrow F, the first coupling part 216 and the second coupling part 115 are engaged with the narrow hole 37. That is, since the upward and downward directions of the upper base 20 and the lower base 10 are restricted by the fastening part 35, the upper base 20 is movable forwardly or backwardly relative to the lower base 10. Moreover, since the first coupling part 216 and the second coupling part 115 are engaged with the narrow hole 37, the movable position-limiting element 38 will not be laterally detached. Moreover, since the narrow hole 37 of the fastening part 35 at the front end of the movable position-limiting element 38 also encloses a fastening block 117 of the lower base, the movable position-limiting element 38 will not be backwardly detached.

Moreover, the front end of the movable position-limiting element 38 has a chamfer angle 312. After the movable position-limiting element 38 is attached on the upper-base sidewall 2103 and the lower-base sidewall 1003, due to the chamfer angle 312, a gap is formed at this end for facilitating the user to remove the movable position-limiting element 38.

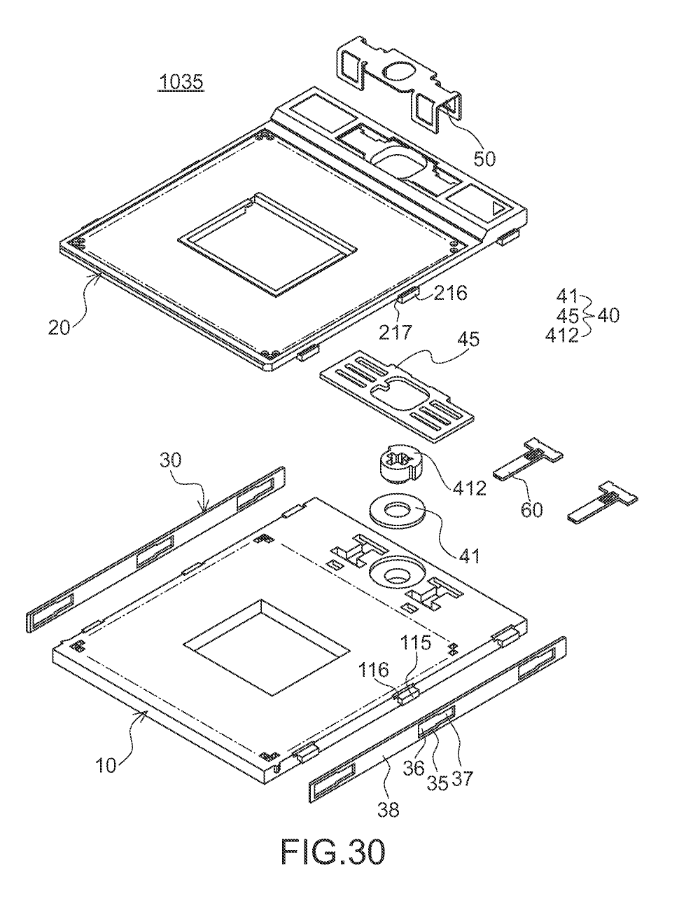

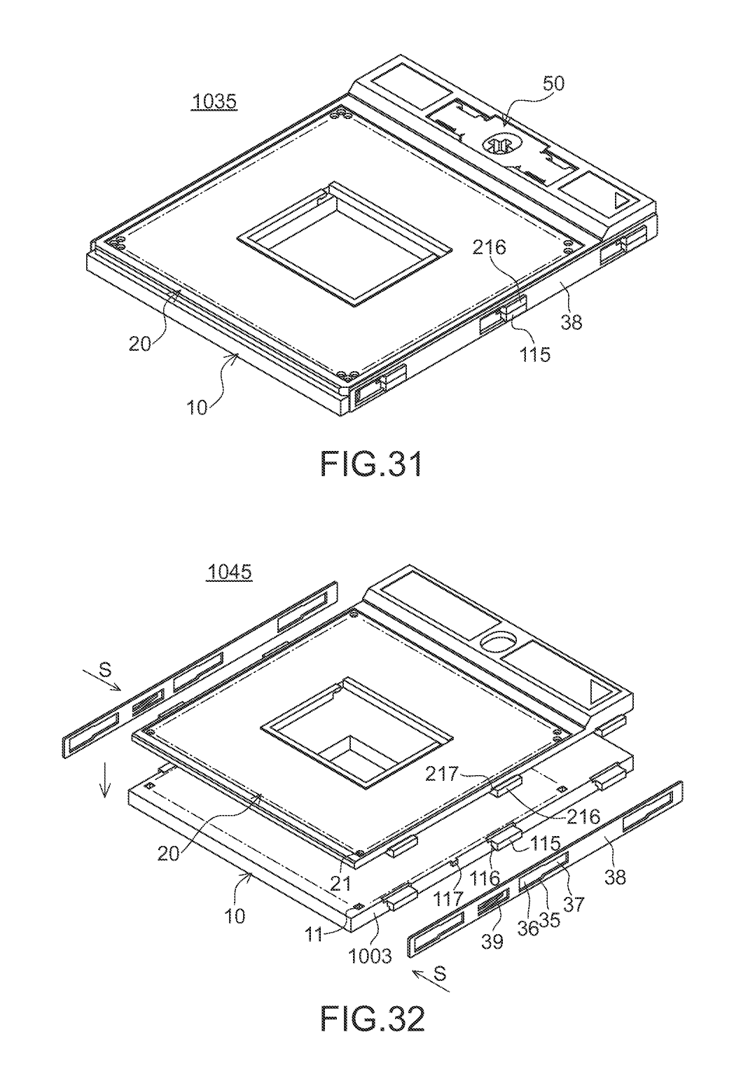

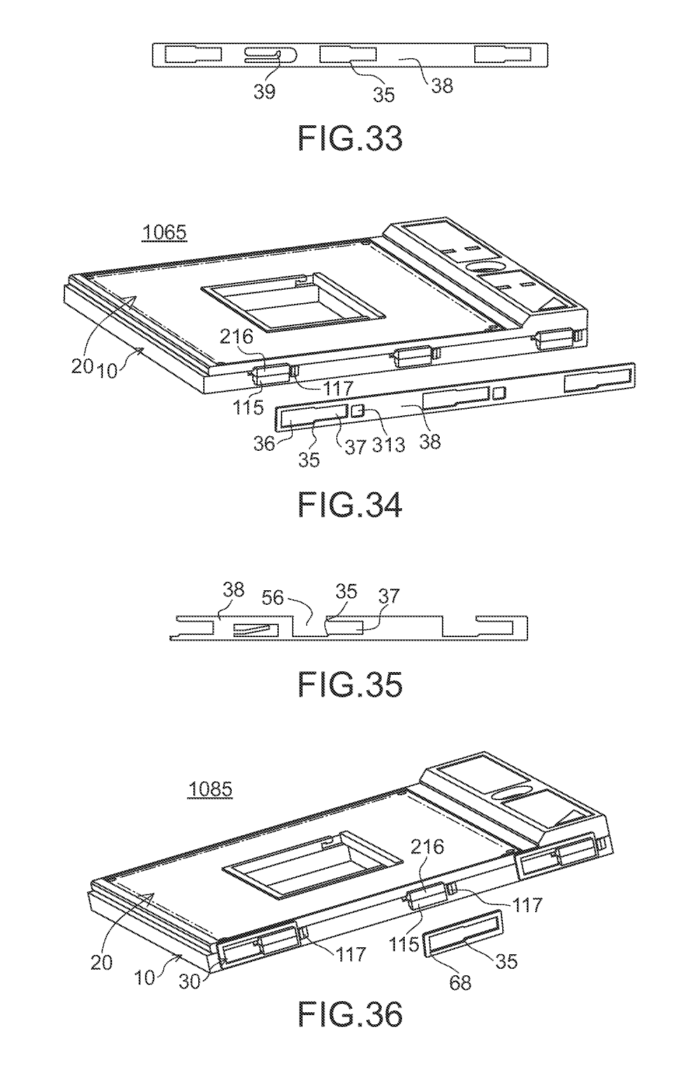

FIGS. 30 and 31 schematically illustrate an electrical connector according to a thirteenth embodiment of the present invention. In comparison with the electrical connector of the twelfth embodiment, the electrical connector 1035 of the thirteenth embodiment further comprises a clamping element 50. The other components are similar to those of the twelfth embodiment, and are not redundantly described herein.

In this embodiment, since one or more coupling parts are discretely arranged on the upper-base sidewall or the lower-base sidewall, the possibility of generating the non-uniform stress or the residual stress during the plastic injection molding process of the upper base and the lower base will be minimized. Therefore, the evenness and yield of the upper base or the lower base will be increased when compared with the conventional covering member having the contiguous side plate.

From the above discussion, it is noted that if the evenness is not taken into consideration, additional structures other than the coupling parts may be disposed on the upper-base sidewall or the lower-base sidewall. Corresponding to the additional structures of the upper-base sidewall or the lower-base sidewall, the movable position-limiting element 38 may have corresponding additional structures.

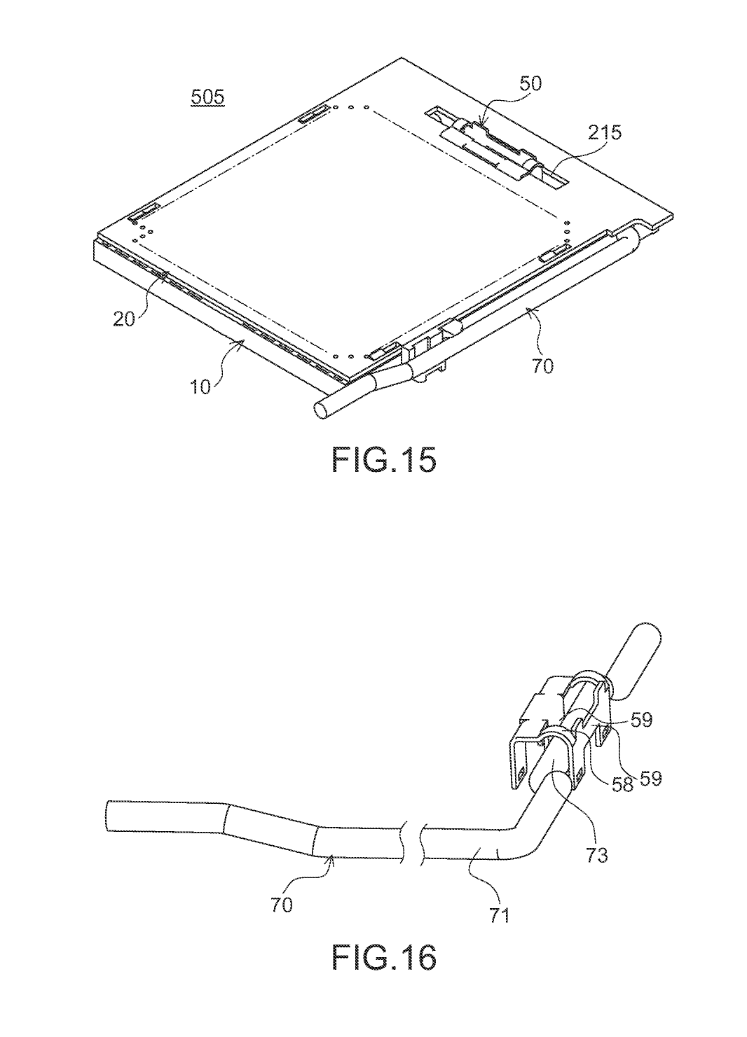

FIG. 32 schematically illustrates an electrical connector according to a fourteenth embodiment of the present invention. A fastening block 117 is disposed on a lower-base sidewall 1003 of the lower base 10 of the electrical connector 1045. In addition, a hooking part (e.g. an elastic inverted hook 39) is disposed on a proper position of the movable position-limiting element 38. After the narrow hole 37 of the movable position-limiting element 38 is engaged with the upward engaging surface 217 of the first coupling part 216 and downward engaging surface 116 of the second coupling part 115, the elastic inverted hook 39 is sustained against the fastening block 117 to prevent backward detachment of the movable position-limiting element 38. It is noted that the shape of the elastic inverted hook 39 is not restricted to the shape of the fourteenth embodiment. For example, in the fifteenth embodiment of FIG. 15, the elastic inverted hook 39 further includes a bending angle.

In the above embodiments, the elastic inverted hook 39 is used to sustain against the fastening block 117. Alternatively, other structures of the movable position-limiting element 38 may be used to sustain against the fastening block 117. FIG. 34 schematically illustrates an electrical connector according to a sixteenth embodiment of the present invention. In the electrical connector 1065, a plurality of fastening holes 313 are disposed on the movable position-limiting element 38. After the movable position-limiting element 38 is sheathed around the second coupling part 115 and the first coupling part 216, the fastening hole 313 is engaged with the fastening block 117 for facilitating positioning the movable position-limiting element 38 on the lower base 10, thereby preventing backward detachment of the movable position-limiting element 38.

FIG. 35 is a schematic side view illustrating a position-limiting element of an electrical connector according to a seventeenth embodiment of the present invention. In comparison with the movable position-limiting element of the twelfth embodiment, an open hole 56 is used to replace the wide hole 36 of the fastening part 35 of the movable position-limiting element 38. That is, the fastening parts 35 is a fastening slot composed of the open hole 56 and the narrow hole 37, which are in communication with each other.

FIG. 36 is a schematic partial assembled view illustrating the electrical connector according to an eighteenth embodiment of the present invention. In comparison with the twelfth embodiment, the electrical connector 1085 comprises a plurality of movable position-limiting portions 68. The movable position-limiting portion 68 is shorter than the length of the sidewall of the upper base 20 (or the lower base 10). Each of the movable position-limiting portions 68 has a single fastening part 35. The other structures of the movable position-limiting portion 68 are similar or identical to those of the movable position-limiting element 38, and are not redundantly described herein.

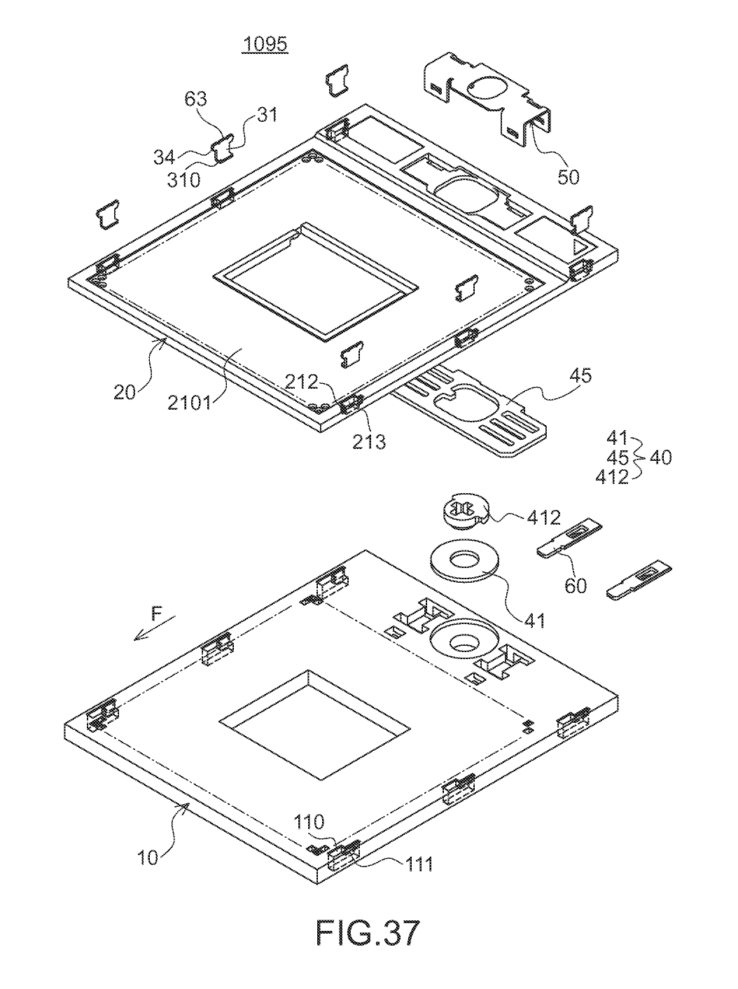

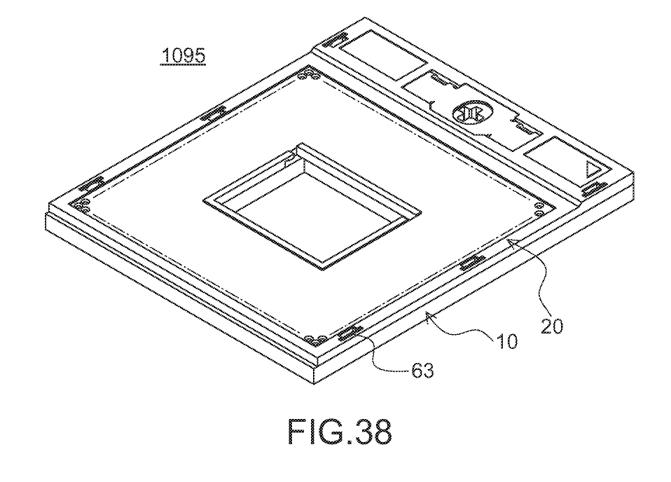

In the above embodiments, the downward engaging surface is provided by the movable engaging piece of the engaging mechanism. During the assembling process, the movable engaging piece is fixed in the lower base, and then the upper base is engaged with the movable engaging piece. However, in some embodiments, the upward engaging surface may also be provided by the movable engaging piece. FIGS. 37 and 38 schematically illustrate an electrical connector according to a nineteenth embodiment of the present invention. In the electrical connector 1095, the engaging structure 30 comprises a plurality of movable engaging pieces 63. Each of the movable engaging pieces 63 is made by bending a metal sheet. The lower segment of the movable engaging piece 63 has a longitudinally-extended side plate 31 and an upward engaging surface 310. The upper segment of the movable engaging piece 63 has a positioning part 34. In addition, a plurality of fastening slots 212 and a plurality of perforations 213 are discretely arranged in both edges of the upper base 20. Moreover, corresponding to the locations of the fastening slots 212 and the perforations 213, a plurality of perforations 110 and a plurality of downward engaging surfaces 111 are discretely arranged in both edges of the lower base 10.

During the assembling process, the upward engaging surface 310 of the movable engaging piece 63 is aligned with the fastening slot 212 of the upper base 20 and the perforation 110 of the lower base 10, and then the upper base 20 is moved in the direction indicated by the arrow F. Consequently, the upward engaging surface 310 is engaged with the downward engaging surface 111 of the lower base 10.

In the nineteenth embodiment, the movable engaging piece provides a movable upward engaging surface to be engaged with the downward engaging surface of the lower base. The movable upward engaging surface is located at a level not higher than the upper-base bottom surface. This design is not detrimental to the evenness of the upper base or the lower base. It is noted that the electronic connector of this embodiment further comprises other components of the above embodiments (e.g. the driving device or the clamping element).

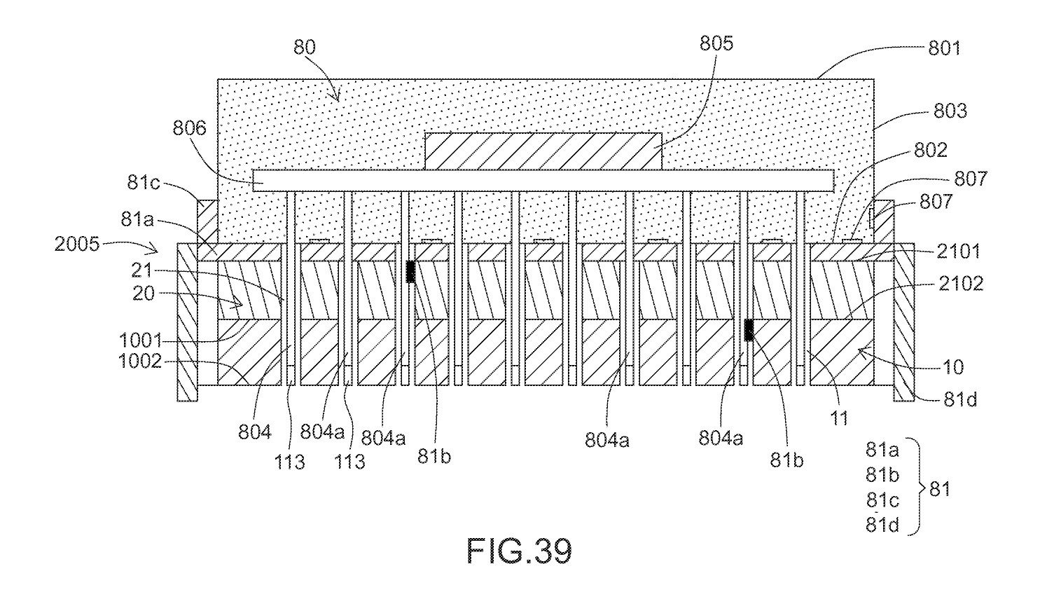

FIG. 39 is a schematic cross-sectional view illustrating a combination of an electrical connector and a chip package according to a twentieth embodiment of the present invention. The electrical connector 2005 is used for supporting a chip package 80 (e.g. a central processing unit). The upper base 20 is an insulating flat plate. A plurality of insertion holes 21 run through the upper-base top surface 2101. These insertion holes 21 are used for accommodating the metal pins 804 and the ground pins 804a of the chip package 80.

The lower base 10 comprises a plurality of terminal slots 11, which run through the lower-base top surface 1001 and the lower-base bottom surface 1002. The terminal slots 11 are aligned with respective insertion holes 21. Each of the terminal slots 11 is used for accommodating a terminal 113. After the lower base 10 is covered by the upper base 20, the terminals 113 are electrically connected with the metal pins 804 and the ground pins 804a which are accommodated within the insertion holes 21.

The chip package 80 comprises a top surface 801, a bottom surface 802, a sidewall 803, a plurality of metal pins 804 and a plurality of ground pins 804a. The sidewall 803 is connected with the top surface 801 and the bottom surface 802. The metal pins 804 and the ground pins 804a are protruded from the bottom surface 802 and electrically connected with the terminals 113. The chip package 80 comprises a chip 805 and a supporting substrate 806. The chip 805 is mounted on the supporting substrate 806. Moreover, the chip 805 is in communication with the external medium outside the chip package 80 through the metal pins 804. The chip package 80 is a CUP chip package or a single chip package with a high operating speed. It is noted that numerous modifications and alterations may be made while retaining the teachings of the invention. For example, the chip package 80 may contain a plurality of chips, which are arranged side by side or arranged in a staked form. In this embodiment of FIG. 39, the metal pins 804 and the ground pins 804a are protruded from the bottom surface 802, penetrated through the insertion holes 21 and inserted into the terminal slots 11 of the lower base 10 to be electrically connected with the terminals 113. Alternatively, in some embodiments, the terminals 113 are extended to the lower-base top surface 1001 of the lower base 10 to be electrically connected with the metal pins 804 and the ground pins 804a.

In comparison with the above embodiments, the upper base or the lower base of the electrical connector 2005 of this embodiment is further provided with a conduction mechanism. The conduction mechanism is used for providing a conduction path, so that a physical signal generated by a working chip 805 of the chip package 80 is transmitted to the external surroundings of the chip package 80 through the conduction path. The top surface 801 of the chip package 80 is not the start point of the conduction path of the conduction mechanism. On the other hand, the package surface excluding the top surface 801 is served as the start point of the conduction path.

Hereinafter, for illustration, the physical signal is heat and the conduction mechanism is a thermal conduction mechanism.

The thermal conduction mechanism 81 is made of metallic material. In addition, the thermal conduction mechanism 81 is disposed on the upper-base top surface 2101, the upper-base bottom surface 2102, the lower-base top surface 1001 and the lower-base bottom surface 1002, and/or within the at least one insertion hole 21 and/or within the at least one terminal slot 11. The thermal conduction mechanism 81 comprises a first thermal conduction mechanism, which is in contact with the bottom surface 802, the sidewall 803 or at least one ground pin 804a. An example of the first thermal conduction mechanism includes but is not limited to a metal plate 81a, an electrically-conductive pad (not shown), a fastener 81b or a metal article 81c. Moreover, in this embodiment, at least one part of the engaging mechanism and/or the driving mechanism is made of metallic material, thereby defining at least one thermal conduction path with the first thermal conduction mechanism.

Moreover, the thermal conduction mechanism 81 further comprises a second thermal conduction mechanism, which is not in contact with the bottom surface 802 or the sidewall 803 of the chip package 80 or not in contact with any metal pin 804 of the metal pins 804 of the chip package 80. For example, the second thermal conduction mechanism includes a thermally-conductive ring 81d, which is disposed around the first thermal conduction mechanism. By the second thermal conduction mechanism, the heat may be transferred from the metal plate 81a to the thermally-conductive ring 81d or other region contacting with the thermally-conductive ring 81d. Alternatively, in some embodiments, the second thermal conduction mechanism includes a metal wire or other heat-dissipating or cooling mechanism. Moreover, at least one thermal conduction path is established between the second thermal conduction mechanism and the first thermal conduction mechanism.

The above thermal conduction mechanisms (e.g. the metal plate 81a, the electrically-conductive pad, the fastener 81b, a metal article 81c or the thermally-conductive ring 81d) may be individually employed or collectively employed. Moreover, the above thermal conduction mechanisms (e.g. the metal plate 81a, the electrically-conductive pad, the fastener 81b, a metal article 81c or the thermally-conductive ring 81d) and the locations of installing the thermal conduction mechanisms may be adjusted according to the practical requirements. Therefore, the heat generated by the working chip package 80 can be transmitted to the external surroundings of the chip package 80 through various conduction paths.

For example, as shown in FIG. 39, if the ground pins 804a are in contact with the metal plate 81a, the heat may be transferred to the large-area metal plate 81a to be quickly dissipated away. Moreover, if the fastener 81b is disposed within a insertion hole 21 of the upper base 20 or a terminal slot 11 of the lower base 10 to be contacted with a corresponding ground pin 804a and a metal wire is arranged between the fastener 81b and the metal plate 81a, the heat may be transferred to the ground pin 804 through the fastener 81b and then transferred to the large-area metal plate 81a through the metal wire, so that the heat can quickly dissipated away. Moreover, if the metal plate 81a and the metal article 81c are in contact with the bottom surface 802 or the sidewall 803 of the chip package 80, the heat of the chip package 80 can be transferred to the external surroundings of the chip package 80 through the metal plate 81a and the metal article 81c. It is to be noted that the descriptions of the three exemplary heat-dissipating ways are presented herein for purpose of illustration and description only.

Moreover, a metallic conductive structure or an encapsulant structure made of a material having a higher thermal conductivity than the chip package 80 may be disposed within the chip package 80 and in the vicinity of the bottom surface 802 or the sidewall 803 of the thermal conduction mechanism so as to be used as an accelerated thermal conduction mechanism 817.

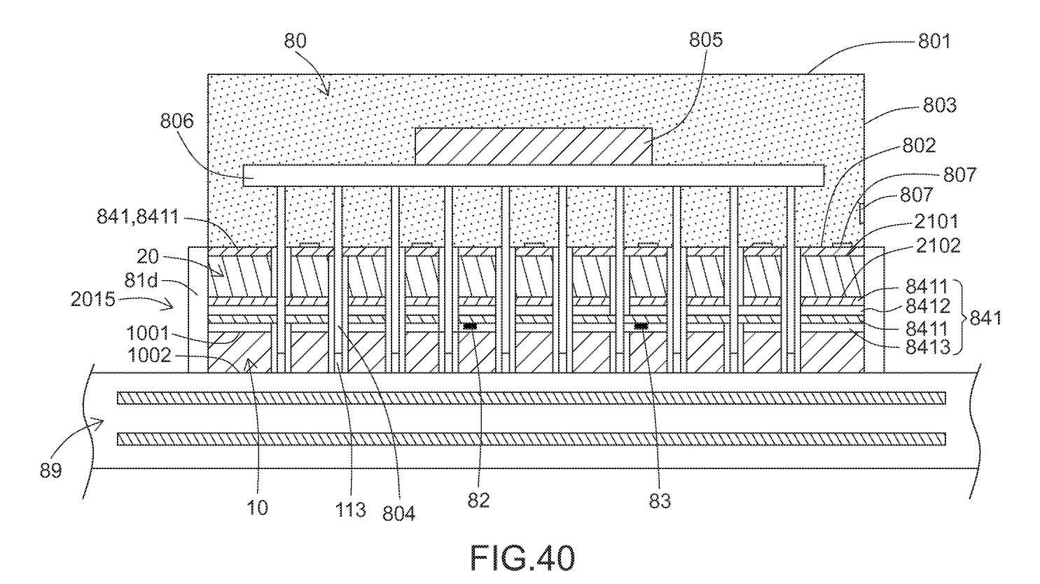

FIG. 40 is a schematic cross-sectional view illustrating a combination of an electrical connector, a chip package and a system board according to a twenty-first embodiment of the present invention. The configurations of the twenty-first embodiment are substantially identical to those of the twentieth embodiment except that the physical signal is an electrical signal, the conduction mechanism is an electrical conduction mechanism and the upper base 20 is a printed circuit board.

In the electrical connector 2015 of the twenty-first embodiment, the metal pins 804 of the chip package 80 are in communication with a system board 89 through the electrical connector 2015. Moreover, the electrical conduction mechanism at least comprises a laminate 841 with one or more electrically-conductive layers 8411. The laminate 841 may be disposed on the upper-base top surface 2101, the upper-base bottom surface 2102, the lower-base top surface 1001 and/or the lower-base bottom surface 1002. The laminate 841 comprises a single layer of electrically-conductive layer 8411 or multiple layers of electrically-conductive layers 8411 to be used as a wiring layer, a ground layer or a power layer. A dielectric layer or an insulating layer 8412 is interposed between adjacent electrically-conductive layers 8411. Like the ordinary printed circuit board, the laminate 841 may be produced by laminating electrically-conductive layers 8411 and insulating layers 8412. In this embodiment, the electrically-conductive layer 8411 is used as a wiring layer, a ground layer or a power layer.

Moreover, the electrically-conductive layer 8411 is a metal layer. Since the metal layer is electrically conductive and has a higher thermal conductivity than the nonmetallic material, the electrically-conductive layer 8411 can be used as a thermal conduction mechanism. Hereinafter, the laminate 841 will be illustrated as an electrical conduction mechanism. However, if a proper insulating measure is made to prevent a short-circuited problem of the metal pins 804 of the chip package 80, the laminate 841 may also be used as a thermal conduction mechanism. The locations and the way of producing the conduction path are similar to those of the twentieth embodiment, and are not redundantly described herein.

Moreover, in this embodiment, the laminate 841 is a printed circuit board. Therefore, the technology associated with the through-hole, the blind hole or the buried hole used in the conventional printed circuit board may be applied to the electrical connector of the present invention to be used as an electrical conduction mechanism. For example, an electrical connection structure (e.g. an electrically-conductive through-hole, an insulating through-hole, an electrically-conductive blind/buried hole, an insulating blind/buried hole or the combination of different holes) may be employed to transmit electrical signal or receive the metal pins 804 (or metallic grab hooks or metallic terminals). According to diversified requirements, different types of metal pins 804 of the chip package 80 are connected to different media. For example, the ground pin is in communication with a ground layer, the power pin is connected with a power layer, and the signal pin is partially interconnected with or in communication with the system board. According to diversified requirements, the laminate 801 provides an electrical conduction path. That is, through the electrically-conductive through-hole, the insulating through-hole, the electrically-conductive blind/buried hole or the insulating blind/buried hole, the electrical conduction path can be connected with the metal pins 804. In such way, the chip package 80 can be in communication with the electrical connector and/or the system board 89.

Moreover, through an additional electrical conduction mechanism installed on the upper base 20 and/or the lower base 10, the signal issued from the system board 89 may be transmitted to the trace pattern or the electrically-conductive layer 8411 of the laminate 841. As mentioned above, since the electrically-conductive layer 8411 of the laminate 841 may be used as a ground layer or a power layer, the ground layer or the power layer that is originally installed on the system board 89 may be changed to the surface of the upper base 20 and/or the lower base 10 of the electrical connector of the present invention. In such way, the number of layers of the system board 89 is decreased, and the fabricating cost of the system board 89 is reduced.

From the above discussions, the laminate 841 of the printed circuit board provides a plurality of electrical conduction paths. Therefore, other electronic components, active/passive electronic components, active/passive electronic structures, electromagnetic interference (EMI) protection elements or electrostatic discharge (ESD) protection elements may be received in or disposed on the laminate 841. In this embodiment, an active/passive electronic component (e.g. a capacitor 82 and an inductor 83) is received in the laminate 841. Through the laminate 841, the chip package 80 and/or the system board 89 may be in communication with the capacitor 82 and the inductor 83. Moreover, since a wiring layer may be included in the laminate 841, the cooperation of the electrically-conductive layer 8411 and the electrically-conductive through-hole, the insulating through-hole, the electrically-conductive blind/buried hole, the metal pin, the metallic grab hook or the metallic terminal may facilitate forming the electronic component or the electronic circuit or the active/passive electronic circuit in the electrical connector. Especially, the the electronic component or the electronic circuit or the active/passive electronic circuit may be formed at the location under the chip package 80 or at the location below and adjacent to the chip package 80

Moreover, in a case that a transient power is possibly needed during operation of the chip package (e.g. a CPU chip package or any other digital IC device), a bypass capacitor is usually employed to provide the transient power to the digital IC device. In this embodiment, a bypass capacitor may be installed on the laminate 841 and then covered by a smoothing layer 8413, so that the bypass capacitor is close to the chip package 80. That is, through the electrical conduction path provided by the laminate 841, the chip package 80 and the system board 89 may be in communication with the electronic components, the active/passive electronic components or the active/passive electronic structures of the laminate 841.

From the above discussions, the region under the chip package 80 may be fully utilized to mount other electronic components or active/passive electronic components or active/passive electronic structures. Therefore, the working path of the chip package is optimized, and the flexibility of selecting the layout space of mounting other electronic components or active/passive electronic components or active/passive electronic structures will be enhanced.

Moreover, various types of electrical conduction structures may be employed. An example of the electrical conduction structure includes but is not limited to a wiring layer of the laminate, a wire, a thermally-conductive pad, any other thermally-conductive terminal, a thermally-conductive driving device, a metal substrate or a metallic fastener. Moreover, the electrical conduction structure may be disposed on a proper location of the upper base, the lower base or the laminate. For example, the electrical conduction structure may be disposed on the electrically-conductive through-hole, the insulating through-hole or the electrically-conductive blind/buried hole, an edge of the upper base or the lower base, the insertion hole or terminal slot. In addition, the electrical conduction structure may be in communication with the metal pins of the chip package, the thermally-conductive layer of the laminate or the system board.

From the above description, by means of the cooperation of the electrical conduction structure and the laminate 841, the signal communication between the chip package 80 and the electrical connector and the signal communication between the chip package 80 and the system board 89 can be established. In other words, the electrical conduction mechanism additionally installed on the upper base 20 and/or the lower base 10 may further comprises a first electrical conduction mechanism and a second electrical conduction mechanism. The first electrical conduction mechanism is in contact with the bottom surface 802 of the chip package 80 or the metal pins 804 of the chip package 80. The second electrical conduction mechanism is disposed on a location of the electrical connector which is not in contact with the chip package 80 (for example in the laminate 841). Moreover, an electrical conduction path is established between the second electrical conduction mechanism and the first electrical conduction mechanism, so that two or three of the chip package 80, the electrical connector and the system board 89 may be in communication with each other.

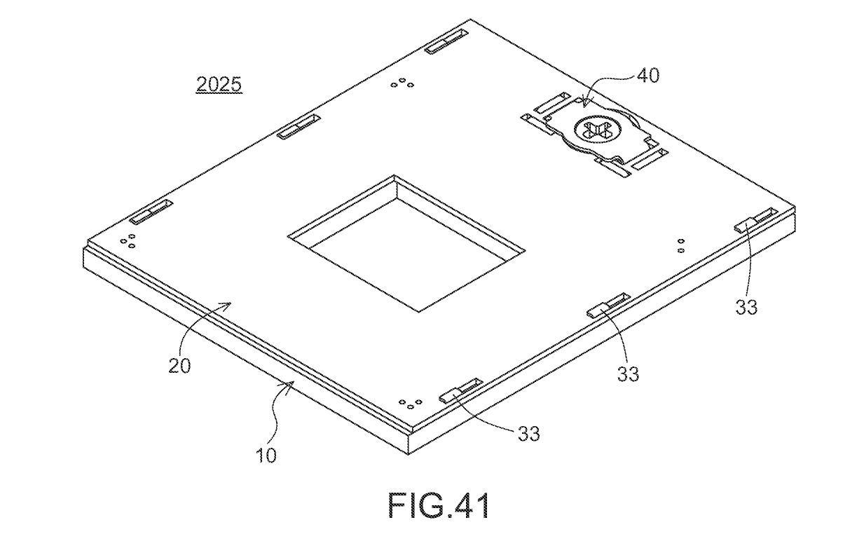

FIG. 41 is a schematic partial assembled view illustrating an electrical connector of the present invention. The electrical connector 2025 is any one of the electrical connectors of the first to twenty-first embodiments. The above-mentioned thermal conduction mechanism may be implemented by at least one of the driving mechanism 40 and the thermal conduction type engaging structure 30. For example, if the movable engaging piece is not included in the engaging mechanism of the above embodiments, the driving mechanism may be used as the thermal conduction mechanism. On the other hand, if the movable engaging piece is included in the engaging mechanism of the above embodiments, the movable engaging piece or both of the movable engaging piece and the driving mechanism may be used as the thermal conduction mechanism.

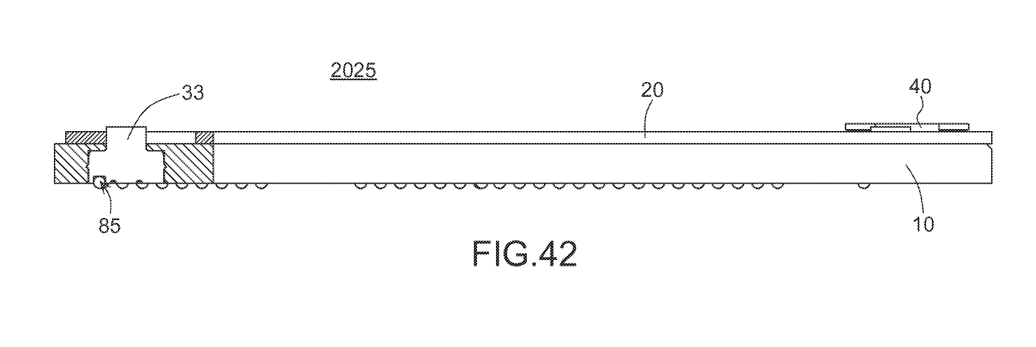

FIG. 42 is a schematic partial cross-sectional view illustrating an electrical connector of the present invention. Before the plurality of movable engaging pieces 33 as shown in FIG. 41 are assembled into the electrical connector 2025, the upper base 20 and the lower base 10 are separate parts. After the upper base 20 and the lower base 10 are combined together through the movable engaging pieces 33, each of the movable engaging pieces 33 may be connected with the underlying system board (not shown) through a solder ball 85, which is made of an electrically-conductive/thermally-conductive material. In such way, the electrical connector 2025 provides a conduction path for leading the physical signal out of the chip package 80 through the upper base 20, the lower base 10 and the solder ball 85.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electrical connector, comprising:
a lower base comprising a terminal slot for accommodating a terminal;
an upper base disposed over said lower base, wherein an outer periphery of said upper base at least comprises an upper-base top surface, an upper-base bottom surface and an upper-base sidewall arranged between said upper-base top surface and said upper-base bottom surface;
an engaging mechanism at least comprising a downward engaging surface and an upward engaging surface, wherein in the case of said downward engaging surface and said upward engaging surface being engaged, said upper base is engaged with said lower base, and said upper base is movable forwardly or backwardly relative to said lower base, and said upward engaging surface is located at a level not lower than said downward engaging surface; and
a driving mechanism arranged between said upper base and said lower base for driving movement of said upper base and lower base forwardly or backwardly relative to each other.

2. The electrical connector according to claim 1, wherein said engaging mechanism further comprises:
a side plate integrally formed with and protruded from a lower-base top surface of said lower base and extended from an edge of said lower base, wherein said downward engaging surface is protruded from a top edge of said side plate; or
a movable engaging piece protruded from at least one of left and right edges of said lower-base top surface, wherein an upper segment of the movable engaging piece has a side plate and a downward engaging surface protruded from a top edge of said side plate, and a lower segment of said movable engaging piece has a positioning part to be positioned in said lower base; or
a first coupling part, a second coupling part and a position-limiting element, wherein said first coupling part is laterally protruded from said upper-base sidewall at a left side and/or a right side of said upper base, and said upward engaging surface is provided by said first coupling part, wherein corresponding to said first coupling part, said second coupling part is laterally protruded from a lower-base sidewall at a left side and/or a right side of said lower base to provide said downward engaging surface, wherein said movable position-limiting element has at least one fastening slot, and said first coupling part and said second coupling part are allowed to be penetrated through said fastening slot and engaged with said fastening slot.

3. The electrical connector according to claim 2, wherein
said upward engaging surface is provided by said upper-base top surface to be engaged with said downward engaging surface; or
said upward engaging surface is provided by a plurality of bulges, which are discretely arranged on said upper-base sidewall at a left or right side of said upper base to be engaged with said downward engaging surface; or
said upward engaging surface is provided by a contiguous bulge, which is arranged on and longitudinally extended from said upper-base sidewall at a left or right side of said upper base, so that said contiguous bulge and a portion of said upper-base top surface at the same side of said contiguous bulge are collectively engaged with said downward engaging surface; or
said upward engaging surface is provided by said upper-base top surface to be engaged with said downward engaging surface which is provided by said movable engaging piece, wherein a first perforation is formed at a left edge and/or a right edge of said upper base, a second perforation and a fastening slot corresponding to said first perforation are formed in a left edge and/or a right edge of said lower base, said movable engaging piece is penetrated through said first perforation and said second perforation, and said positioning part is positioned in said fastening slot; or
a first perforation is formed in a left edge and/or a right edge of said upper-base top surface corresponding to said downward engaging surface of said movable engaging piece, said upward engaging surface is arranged in said first perforation and exposed to said upper-base top surface, a second perforation and a fastening slot corresponding to said first perforation are formed in said left edge and/or said right edge of said lower base, and said movable engaging piece is penetrated through said first perforation and said second perforation to be engaged with said upward engaging surface; or
a notch is formed in a left edge and/or a right edge of said upper-base top surface corresponding to said downward engaging surface of said movable engaging piece, said upward engaging surface is arranged in said notch and exposed to said upper-base top surface, a perforation and a fastening slot corresponding to said first perforation are formed in said left edge and/or said right edge of said lower base, and said movable engaging piece is penetrated through said perforation and said notch to be engaged with said upward engaging surface;
said upward engaging surface is provided by said upper-base top surface to be engaged with said downward engaging surface, and a notch is formed in a left edge and/or a right side of said upper base, wherein after said upper base is placed on said lower base from top to bottom, said downward engaging surface provided by said movable engaging piece is received by said notch; or
said positioning part of said movable engaging piece has an elastic inverted hook for facilitating fixing said movable engaging piece in said lower base; or
said fastening slot of said movable position-limiting element comprises a wide hole and a narrow hole, which are in communication with each other, wherein said first coupling part and said second coupling part are penetrated through said wide hole, and said narrow hole is engaged with said first coupling part and said second coupling part;
said movable position-limiting element comprises a plurality of separate movable position-limiting portions, and said fastening slot of each movable position-limiting element comprises a wide hole and a narrow hole, which are in communication with each other, wherein said first coupling part and said second coupling part are penetrated through said wide hole, and said narrow hole is engaged with said first coupling part and said second coupling part; or
said fastening slot of said movable position-limiting element comprises an open hole and a narrow hole, wherein said first coupling part and said second coupling part are penetrated through said open hole, and said narrow hole is engaged with said first coupling part and said second coupling part.

4. The electrical connector according to claim 3, wherein said upper base is an insulating flat plate, and said driving mechanism comprises:
a handle comprising a lever part and a pivotal part, wherein a shaft is disposed at both ends of said pivotal part, a cam is disposed at a middle of said pivotal part, and said shaft is coupled with said lower base, wherein upon rotation of said cam, said upper base is driven to be moved relative to said lower base; or
a moving element and a pushing element, wherein said upper base has an opening, said moving element has a through-hole and is coupled to and fixed on said base, said pushing element has a slot in a top surface thereof and an eccentric cam corresponding to a center of said slot, said eccentric cam is received within said through-hole, and said slot is exposed to said opening of said upper base, wherein upon rotation of said pushing element, said moving element is pushed by said eccentric cam, so that said upper base is driven to be moved relative to said lower base.

5. The electrical connector according to claim 2, wherein said upper base is an insulating flat plate, and said upper-base top surface and said upper-base bottom surface are flat and have no protruding structure, and
said side plate of said lower base is a contiguous plate, and said downward engaging surface is divided into multiple segments of separate surfaces; or
said downward engaging surface is divided into multiple segments of separate first surfaces, and said side plate is divided into multiple segments of separate second surfaces and engaged with said downward engaging surface; or
corresponding to said movable engaging piece, at least one fastening slot is formed in a left edge and/or a right edge of said low-base top surface of said lower base.

6. The electrical connector according to claim 5, wherein
said upward engaging surface is provided by said upper-base top surface to be engaged with said downward engaging surface; or
said upward engaging surface is provided by a plurality of bulges, which are discretely arranged on said upper-base sidewall at a left or right side of said upper base to be engaged with said downward engaging surface; or
said upward engaging surface is provided by a contiguous bulge, which is arranged on and longitudinally extended from said upper-base sidewall at a left or right side of said upper base, so that said contiguous bulge and a portion of said upper-base top surface at the same side of said contiguous bulge are collectively engaged with said downward engaging surface; or
said upward engaging surface is provided by said upper-base top surface to be engaged with said downward engaging surface which is provided by said movable engaging piece, wherein a first perforation is formed in a left edge and/or a right side of said upper base, a second perforation and a fastening slot corresponding to said first perforation are formed in a left edge and/or a right side of said lower base, said movable engaging piece is penetrated through said first perforation and said second perforation, and said positioning part is positioned in said fastening slot; or
a first perforation is formed in a left edge and/or a right edge of said upper-base top surface corresponding to said downward engaging surface of said movable engaging piece, said upward engaging surface is arranged in said first perforation and exposed to said upper-base top surface, a second perforation and a fastening slot corresponding to said first perforation are formed in said left edge and/or said right edge of said lower base, and said movable engaging piece is penetrated through said first perforation and said second perforation to be engaged with said upward engaging surface;
a notch is formed in a left edge and/or a right edge of said upper-base top surface corresponding to said downward engaging surface of said movable engaging piece, said upward engaging surface is arranged in said notch and exposed to said upper-base top surface, a perforation and a fastening slot corresponding to said first perforation are formed in said left edge and/or said right edge of said lower base, and said movable engaging piece is penetrated through said perforation and said notch to be engaged with said upward engaging surface; or
said upward engaging surface is provided by said upper-base top surface to be engaged with said downward engaging surface, and a notch is formed in a left edge and/or a right side of said upper base, wherein after said upper base is placed on said lower base from top to bottom, said downward engaging surface provided by said movable engaging piece is received by said notch.

7. A method for fabricating an upper base of an electrical connector, said method comprising steps of:
providing an insulating flat plate;
punching said insulating flat plate; and
cutting said insulating flat plate into said upper base, so that multiple rows of insertion holes are formed in said upper base.

8. The method for fabricating the upper base of the electrical connector according to claim 1, wherein
said insulating flat plate is a plastic flat plate or a glass fiber flat plate; or
said upper base is configured to support at least one central processing unit (CPU).

9. An electrical connector, comprising:
a lower base comprising a plurality of terminal slots for accommodating a plurality of terminals;
an upper base for covering said lower base, wherein an outer periphery of said upper base at least comprises an upper-base top surface, an upper-base bottom surface and an upper-base sidewall arranged between said upper-base top surface and said upper-base bottom surface, wherein said upper base is an insulating flat plate, and said upper-base top surface and said upper-base bottom surface are even and non-warped;
an engaging structure for engaging said upper base with said lower base, so that said upper base is engaged with said lower base and said upper base is movable forwardly or backwardly relative to said lower base; and
a driving mechanism arranged between said upper base and said lower base for driving movement of said upper base and lower base forwardly or backwardly relative to each other.

10. The electrical connector according to claim 9, further comprising:
a conduction mechanism installed on at least one of said upper base and said lower base for transferring a physical signal; and
a chip package supported on said upper base, and comprising a top surface, a bottom surface, a sidewall connected with said top surface and said bottom surface and a plurality of metal pins protruded outside said chip package, wherein said metal pins are penetrated through a plurality of insertion holes to be electrically connected with respective terminals.

11. The electrical connector according to claim 10, wherein said conduction mechanism comprises a thermal conduction mechanism or an electrical conduction mechanism, wherein said thermal conduction mechanism is disposed on said upper-base top surface, said upper-base bottom surface, a lower-base top surface of said lower base, a lower-base bottom surface of said lower base, within at least one of said insertion holes, within at least one of said terminal slots and/or on at least one of said metal pins, wherein said electrical conduction mechanism comprises a laminate with at least one electrically-conductive layer, and said laminate is disposed on a part of said upper base or said lower base.

12. The electrical connector according to claim 10, wherein said conduction mechanism comprises a thermal conduction mechanism or an electrical conduction mechanism, and
said thermal conduction mechanism comprises a first thermal conduction mechanism, which is in contact with said bottom surface or said sidewall of said chip package or in contact with at least one signal pin, one ground pin or one power pin of said metal pins of said chip package, wherein said first thermal conduction mechanism is a metal plate, an electrically-conductive pad, a fastener, a wire or a solder ball; or
at least one part of said engaging structure and said driving mechanism is made of a metallic material, and at least one thermal conduction path is established between said part and said first thermal conduction mechanism; or
said thermal conduction mechanism comprises a first thermal conduction mechanism and a second thermal conduction mechanism, wherein said first thermal conduction mechanism is in contact with said bottom surface or said sidewall of said chip package or in contact with at least one signal pin, one ground pin or one power pin of said metal pins of said chip package, said second thermal conduction mechanism is not in contact with said bottom surface or said sidewall of said chip package or not in contact with each of said metal pins, and at least one thermal conduction path is established between said second thermal conduction mechanism and said first thermal conduction mechanism; or
said electrical conduction mechanism comprises a laminate with at least one electrically-conductive layer, and said laminate is disposed on a part of said upper base or said lower base; or
said electrical conduction mechanism at least comprises a first electrical conduction mechanism and a second electrical conduction mechanism, wherein said first electrical conduction mechanism is in contact with said bottom surface of said chip package or said metal pins of said chip package, said second electrical conduction mechanism is disposed on a location of said electrical connector which is not in contact with said chip package, and an electrical conduction path is established between said second electrical conduction mechanism and said first electrical conduction mechanism.

13. The electrical connector according to claim 12, wherein
said electrically-conductive layer at least comprises a ground layer or a power layer; or
at least one metal substrate, one metal wire, one thermally-conductive pad, one thermally-conductive terminal, one thermally-conductive hole, one metallic fastener or one solder ball is disposed on said laminate to be electrically with at least one signal pin, one ground pin or one power pin of said metal pins; or
said second thermal conduction mechanism comprises a thermally-conductive ring or a solder ball or other heat-dissipating or cooling mechanism; or
an electronic component is further in communication with said electrical conduction mechanism, wherein said electronic component includes a capacitor, a capacitive structure, an inductor, an inductive structure, an active/passive electronic component, an active/passive electronic structure, an electromagnetic interference (EMI) protection element or an electrostatic discharge (ESD) protection element.

14. The electrical connector according to claim 9, wherein each of said upper base and said lower base further comprises a thermal conduction mechanism or an electrical conduction mechanism, at least one part of said engaging structure and said driving mechanism is made of a metallic material, and at least one thermal conduction path is established between said part and said first thermal conduction mechanism.

15. The electrical connector according to claim 14, wherein said electrical conduction mechanism comprises a laminate with at least one electrically-conductive layer, and said laminate is disposed on a part of said upper base or said lower base.

16. The electrical connector according to claim 14, wherein said engaging structure comprises a movable engaging piece, which is protruded from at least one of left and right edges of a lower-base top surface of said lower base, wherein an upper segment of the movable engaging piece has a side plate and a downward engaging surface protruded from a top edge of said side plate, a lower segment of said movable engaging piece has a positioning part to be positioned in said lower base, and said thermal conduction path is established between said part and said thermal conduction mechanism through said movable engaging piece.

17. The electrical connector according to claim 14, wherein said driving mechanism comprises:
a handle comprising a lever part and a pivotal part, wherein a shaft is disposed at both ends of said pivotal part, a cam is disposed at a middle of said pivotal part, and said shaft is coupled with said lower base, wherein upon rotation of said cam, said upper base is driven to be moved relative to said lower base; or
a moving element and a pushing element, wherein said upper base has an opening, said moving element has a through-hole and is coupled to and fixed on said base, said pushing element has a slot in a top surface thereof and an eccentric cam corresponding to a center of said slot, said eccentric cam is received within said through-hole, and said slot is exposed to said opening of said upper base, wherein upon rotation of said pushing element, said moving element is pushed by said eccentric cam, so that said upper base is driven to be moved relative to said lower base.

18. An electrical connector, comprising:
a lower base comprising a terminal slot for accommodating a terminal;
an upper base disposed over said lower base, wherein an outer periphery of said upper base at least comprises an upper-base top surface, an upper-base bottom surface and an upper-base sidewall arranged between said upper-base top surface and said upper-base bottom surface;
an engaging structure at least comprising a movable upward engaging surface and a downward engaging surface installed on said lower base, wherein after said movable upward engaging surface is engaged with said downward engaging surface, said upper base is engaged with said lower base and said upper base is movable forwardly or backwardly relative to said lower base, wherein said movable upward engaging surface is located at a level not higher than said downward engaging surface; and
a driving mechanism arranged between said upper base and said lower base for driving movement of said upper base and lower base forwardly or backwardly relative to each other.

19. The electrical connector according to claim 18, wherein said driving mechanism comprises:
a handle comprising a lever part and a pivotal part, wherein a shaft is disposed at both ends of said pivotal part, a cam is disposed at a middle of said pivotal part, and said shaft is coupled with said lower base, wherein upon rotation of said cam, said upper base is driven to be moved relative to said lower base; or
a moving element and a pushing element, wherein said upper base has an opening, said moving element has a through-hole and is coupled to and fixed on said base, said pushing element has a slot in a top surface thereof and an eccentric cam corresponding to a center of said slot, said eccentric cam is received within said through-hole, and said slot is exposed to said opening of said upper base, wherein upon rotation of said pushing element, said moving element is pushed by said eccentric cam, so that said upper base is driven to be moved relative to said lower base.

20. The electrical connector according to claim 19, wherein each of said upper base and said lower base further comprises a thermal conduction mechanism or an electrical conduction mechanism, at least one part of said engaging structure and said driving mechanism is made of a metallic material, and at least one thermal conduction path is established between said part and said first thermal conduction mechanism.
